(19) United States
(12) Patent Application Publication
(10) Pub. No.: US 2016/0180498 A1
(43) Pub. Date: Jun. 23, 2016

(54) IMAGE DISPLAY DEVICE, IMAGE PROCESSING DEVICE, AND IMAGE PROCESSING METHOD

(71) Applicant: SONY CORPORATION, Minato-ku, Tokyo (JP)

(72) Inventors: Naoki Kobayashi, Tokyo (JP); Yohsuke Kaji, Chiba (JP); Naomasa Takahashi, Chiba (JP); Yoichi Hirota, Kanagawa (JP)

(21) Appl. No.: 14/910,167

(22) PCT Filed: Jul. 7, 2014
(86) PCT No.: PCT/JP2014/003582

§ 371 Date: Feb. 4, 2016

(30) Foreign Application Priority Data
Aug. 23, 2013 (JP) 2013-172905

(51) Int. Cl. G06T 3/00; G06T 15/00

(52) U.S. Cl. CPC G06T 3/0056; G06T 15/00; G06T 2215/06

(57) ABSTRACT

An image display device includes an image input unit which inputs an image; a display unit which displays the image; and an image conversion unit which converts an input image so that a display image on the display unit is viewed as an image which is displayed in a predetermined format.

### CROSS REFERENCE TO RELATED APPLICATIONS

This application claims the benefit of Japanese Priority Patent Application JP 2013-172905 filed Aug. 23, 2013, the entire contents of which are incorporated herein by reference.

### TECHNICAL FIELD

The present technology relates to an image display device which allows a viewer to view a projected image of a display image, an image processing device which processes the projected original display image, and an image processing method thereof.

### BACKGROUND ART

A head mounted image display device which is used when viewing an image by wearing the device on the head, that is, a head mounted display has been known. In general, the head mounted image display device includes an image display unit for each left and right eye, and is configured so as to control vision and hearing by using headphones together. In addition, it is also possible for the head mounted image display device to project different images for the left and right eyes, and to present a three-dimensional image when an image with parallax is displayed to the left and right eyes.

The head mounted image display device includes a display panel as a display unit of the left and right eyes, and an optical system which projects a display image thereof, and provides a virtual image to a user (that is, causes virtual images to be formed on retinas of eyes). Here, the virtual image is an image which is formed on an object side when the object is present at a position which is closer to a lens than a focal distance. In addition, in the display panel, for example, a display element with high resolution such as liquid crystal, or an organic Electro-Luminescence (EL) element is used.

When a user is allowed to view a virtual image, it is preferable that a distance of a formed virtual image from the user be variable depending on an image. For example, a display device which provides a virtual image in a form which is suitable for the image has been proposed (refer to PTL 1, for example). The display device includes a magnification optical system which arranges the same virtual image which is viewed from the left and right eyes of a user on the same plane, and controls a distance of the virtual image from the user, and a size of the virtual image according to an aspect ratio of the image.

In addition, a head mounted display which simulates a state in which realistic feeling can be obtained such as a viewer watching a movie at the theater, by setting an appropriate view angle using an optical lens which projects a display screen, and reproducing multichannel using headphones has been proposed (for example, refer to PTL 2). The head mounted display includes a wide angle optical system which is arranged in front of the pupils of a user by being separated by 25 mm, and a display panel with a size of an effective pixel range of 0.7 inches in front of the wide angle optical system, and the wide angle optical system forms a virtual image of approximately 750 inches on user's retinas 20 m in front of the pupils of the user. This corresponds to reproducing an angle of view of approximately 45 deg which is comfortable for viewing an image on a screen in a movie theater.

### CITATION LIST

### Patent Literature

### [PTL 1]

### Japanese Unexamined Patent Application Publication No. 2007-133415

### [PTL 2]

### Japanese Unexamined Patent Application Publication No. 2012-141461

### SUMMARY

### Technical Problem

It is desirable to provide an excellent image processing device which can present an image in a state which is desired by a user.

It is desirable to further provide an excellent image processing device which can process an image so as to present the image in a state which is desired by a user, and an image processing method thereof.

### Solution to Problem

According to an embodiment of the present technology, there is provided an image display device which includes an image input unit which inputs an image; a display unit which displays the image; and an image conversion unit which converts an input image so that a display image on the display unit is viewed as an image which is displayed in a predetermined format.

In the image display device, the image conversion unit may convert the input image so that the image is viewed as an image projected onto a curved screen using a projector.

In the image display device, the image conversion unit may perform image conversion with respect to the input image so that image information of each point when the input image is projected onto the curved screen from a projection center of the projector is displayed at a point at which a gaze of a user who views the image information reaches the display image of the display unit.

In the image display device, the image conversion unit may convert the input image so that the input image is viewed as an image which is presented on a curved panel.

In the image display device, the image conversion unit may perform image conversion with respect to the input image so that image information of each point when the input image is presented on the curved panel is displayed at a point at which the gaze of the user viewing the image information reaches the display image of the display unit.

In the image display device, the image conversion unit may include a conversion table which maintains a conversion vector in which a correlation between a pixel position on the input image and a pixel position on a presented image which is output from the display unit is described only for a pixel of a representative point, and a table interpolation unit which interpolates a conversion vector of a pixel except for the representative point from the conversion table, and may perform a conversion of the input using the interpolated conversion vector.

In the image display device, the image conversion unit may perform the conversion of the input image by separating the conversion into a vertical direction and horizontal direction.

In the image display device, the image conversion unit may further include a V conversion table and an H conversion table which maintain a V conversion vector in the vertical direction and an H conversion vector in the horizontal direction with respect to a representative point, respectively, a V table interpolation unit which interpolates the V conversion vector of a pixel except for the representative point from the V conversion table, and an H table interpolation unit which interpolates the H conversion vector of a pixel except for the representative point from the H conversion table.

In the image display device, the V table interpolation unit and the H table interpolation unit may perform a table interpolation with respect to a pixel in the vertical direction based on one dimensional weighted sum of a conversion vector of a representative point which is maintained in the conversion table, and then perform a table interpolation with respect to a pixel in the horizontal direction based on one dimensional weighted sum of a conversion vector of the pixel which is interpolated in the vertical direction.

In the image display device, the V table interpolation unit and the H table interpolation unit may interpolate a conversion vector of a pixel at a representative position which is arranged in pixel intervals of exponent of 2 using a weighted sum by calculating a weight of a neighboring representative point, and may interpolate a conversion vector of a pixel between the representative positions using a two tap weighted sum at even intervals, when the table interpolation is performed with respect to a pixel in the horizontal direction.

In the image display device, the image conversion unit may further include a pixel value V conversion unit which performs conversion in the vertical direction with respect to the input image using a V conversion vector which is interpolated by the V table interpolation unit, and a pixel value H conversion unit which performs conversion in the horizontal direction with respect to a converted image by the pixel value V conversion unit using an H conversion vector which is interpolated by the H table interpolation unit.

In the image display device, the display unit may display an image in each of the left and right eyes of a user, and the image conversion unit may include only a conversion table for image of any one of the left and right eyes, and may obtain a conversion vector for the other eye by performing horizontal inversion of the conversion vector for the one eye which is interpolated by the table interpolation unit.

In the image display device, the image input unit may input an image for left eye and an image for right eye, and the image conversion unit may perform the conversion after performing a format conversion of the input images for left and right eyes into a format in which the images are alternately inserted line by line.

In the image display device, the image conversion unit may perform the conversion with respect to the input image after performing de-gamma processing with respect to the image.

According to another embodiment of the present technology, there is provided an image processing device which includes an image conversion unit which converts an image which is displayed on a display unit so that the image is viewed as an image displayed in a predetermined format.

According to further another embodiment of the present technology, there is provided an image processing method which includes converting an image which is displayed on a display unit so that the image is viewed as an image displayed in a predetermined format.

### Advantageous Effects of Invention

According to the technology which is disclosed in the specification, it is possible to provide an excellent image display device which can simulate a state in which an image displayed in a desired format is viewed.

In addition, according to the technology which is disclosed in the specification, it is possible to provide an excellent image processing device and image processing method which can process the original image so that a projected image of a display image can be viewed as an image displayed in a desired format.

In addition, the effect which is disclosed in the specification is only an example, and the effect in the technology is not limited to this. In addition, there is a case in which the technology exhibits a further additional effect in addition to the above described effect.

Further another objects, characteristics, or advantages of the technology disclosed in the specification will be clarified by detailed descriptions based on embodiments which will be described later, or accompanying drawings.

### BRIEF DESCRIPTION OF DRAWINGS

FIG. 1 is a diagram which illustrates a state in which a user wearing a head mounted display is viewed from the front.

FIG. 2 is a diagram which illustrates a state in which the user wearing the head mounted display is viewed from above.

FIG. 3 is a diagram which illustrates an internal configuration example of the head mounted display.

FIG. 4 is a diagram in which a state of a user who is viewing an image simulated as if the image is projected onto a curved screen using a projector is perspectively viewed.

FIG. 5 illustrates a state in which the state in FIG. 4 is viewed from above.

FIG. 6 illustrates a state in which the state in FIG. 4 is viewed from the side.

FIG. 7 is a diagram in which a state of a user who is viewing an image simulated as if the image is presented on a curved panel is perspectively viewed.

FIG. 8 illustrates a state in which the state in FIG. 7 is viewed from above.

FIG. 9 illustrates a state in which the state in FIG. 7 is viewed from the side.

FIG. 10 is a diagram which illustrates a relationship between an input image and an image which is presented by the curved panel.

FIG. 11 is a diagram which illustrates an example of the input image.

FIG. 12 is a diagram which illustrates an image which is converted so that a state in which a user is viewing an image which is formed by projecting the input image illustrated in FIG. 11 onto the curved screen using the projector with the left eye is simulated.

FIG. 13 is a diagram which illustrates an image which is converted so that a state in which the viewer is viewing the image which is formed by projecting the input image illustrated in FIG. 11 onto the curved screen with the right eye is simulated.

FIG. 14 is a diagram which illustrates an image which is converted so that a state in which the viewer is viewing the image which is formed by presenting the input image illustrated in FIG. 11 onto the curved panel with the left eye is simulated.

FIG. 15 is a diagram which illustrates an image which is converted so that a state in which the viewer is viewing the image which is formed by projecting the input image illustrated in FIG. 11 onto the curved panel with the right eye is simulated.

FIG. 16 is a functional block diagram for performing image conversion so that an input image is viewed as an image which is displayed in another form.

FIG. 17 is a diagram which schematically illustrates a state in which a conversion table storage unit maintains a conversion vector only for a representative point.

FIG. 18 is a diagram which schematically illustrates a state in which a conversion vector of a display pixel except for the representative point is obtained using interpolation processing.

FIG. 19 is a diagram which exemplifies a method of interpolation processing of a conversion table when not being separated into a horizontal direction and a vertical direction.

FIG. 20 is a diagram which describes a method of interpolating the conversion table when being separated into the horizontal direction and the vertical direction.

FIG. 21 is a diagram which describes a method of interpolating the conversion table when being separated into the horizontal direction and the vertical direction.

FIG. 22A is a diagram which describes a hybrid interpolating method in which interpolation processing in the horizontal direction (H interpolation) of the conversion vector is reduced.

FIG. 22B is a diagram which describes the hybrid interpolating method in which interpolation processing in the horizontal direction (H interpolation) of the conversion vector is reduced.

FIG. 23 is a diagram which describes a method of H interpolation when the method described in FIGS. 22A and 22B is not adopted.

FIG. 24 is a diagram which schematically illustrates a processing order in which image processing is performed by being separated into conversion processing in the vertical direction, and conversion processing in the horizontal direction.

FIG. 25 is a diagram which illustrates an example in which two-dimensional image conversion processing is performed.

FIG. 26A is a diagram which illustrates an example in which image processing is performed by being separated into conversion processing in the vertical direction, and conversion processing in the horizontal direction.

FIG. 26B is a diagram which illustrates an example in which the image processing is performed by being separated into the conversion processing in the vertical direction, and the conversion processing in the horizontal direction.

FIG. 27 is a block diagram of a circuit in an image conversion functional unit.

FIG. 28 is a diagram which illustrates a mechanism in which an input image is subject to a format conversion by a format conversion unit.

FIG. 29 is a diagram which exemplifies a relationship between a signal value of an image signal which is subject to a gamma correction and luminance.

### DESCRIPTION OF EMBODIMENTS

Hereinafter, embodiments of the present technology will be described in detail with reference to drawings.

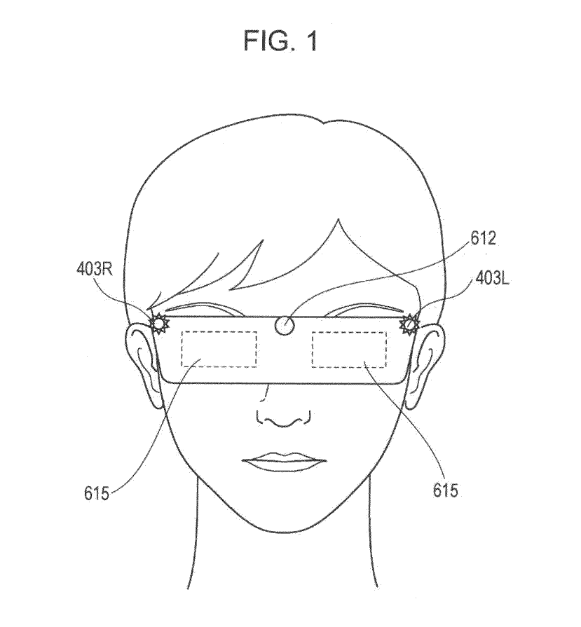

FIG. 1 illustrates a state in which a user wearing a head mounted display is viewed from the front side.

The head mounted display directly covers eyes of a user when the user wears the head mounted display on the head or face, and can provide the user a sense of immersion while viewing an image. In addition, the user is able to indirectly view scenery in a real world (that is, display scenery using video see-through) when being provided with an outer camera 612 which photographs scenery in a gaze direction of the user, and displaying an imaged image thereof. In addition, it is possible to display a virtual display image such as an Augmented Reality (AR) image by overlapping the image with a video see-through image. In addition, since the display image is not viewed from the outside (that is, others), it is easy to maintain privacy when displaying information.

The illustrated head mounted display is a structure which is similar to a hat shape, and is configured so as to directly cover both eyes of a user who is wearing the head mounted display. A display panel (not shown in FIG. 1) which the user views is arranged at a position of the inside of a main body of the head mounted display which faces the left and right eyes. The display panel is configured of a micro display which is formed of a two-dimensional screen, basically, for example, an organic EL element, a liquid crystal display, or the like.

As illustrated, the outer camera 612 for inputting a peripheral image (field of vision of user) is provided in an approximately center of the front face of the main body. In addition, microphones 403L and 403R are respectively provided in the vicinity of left and right ends of the main body of the head mounted display. By being provided with the microphones 403L and 403R approximately symmetrically on the left and right, and by recognizing only a sound in the center (voice of user), it is possible to separate noise in the periphery or voices of others from the sound in the center, and to prevent a malfunction at a time of an operation using a sound input, for example. However, an input device such as the outer camera, or the microphone is not a necessary constituent element of the technology which is disclosed in the specification.

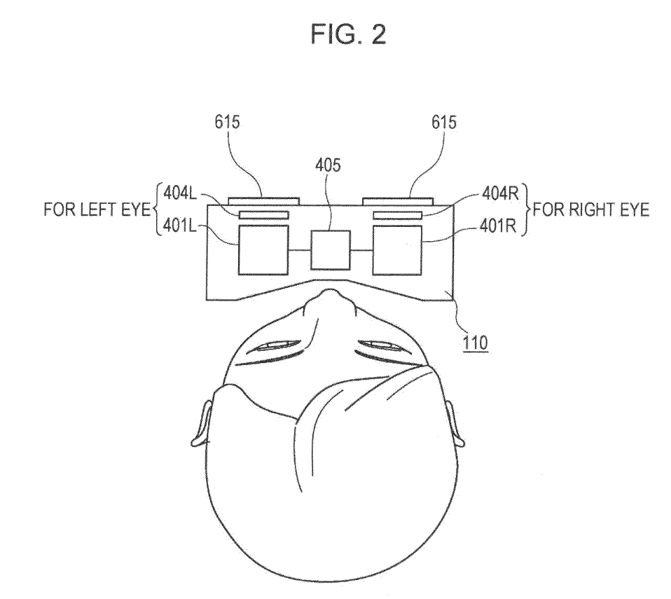

FIG. 2 illustrates a state in which the user who is wearing the head mounted display illustrated in FIG. 1 is viewed from above. The illustrated head mounted display includes display panels 404L and 404R for left and right eyes on a side surface facing a face of the user. The display panels 404L and 404R are configured of, for example, a micro display such as an organic EL element, or a liquid crystal display. Virtual image optical units 401L and 401R project display images of the display panels 404L and 404R, respectively, by enlarging thereof, and form the images on retinas of the left and right eyes of the user. Accordingly, the display images of the display panels 404L and 404R are viewed by the user as enlarged virtual images passing through the virtual image optical units 401L and 401R. In addition, since there is an individual difference in the height and width of eyes in each user, it is necessary to perform position alignment of each display system on the left and right, and of eyes of the user who is wearing the head mounted display. In the example illustrated in FIG. 2, an eye width adjusting mechanism 405 is provided between the display panel for right eye and the display panel for left eye.

In addition, an outer display unit 615 which displays an outer image which can be viewed by an outsider is arranged outside the main body of the head mounted display. In the illustrated example, a pair of the left and right outer display units 615 is included, however, a single outer display unit 615, or three or more outer display units 615 may be provided. The outer image may be either the same image as that on the display unit 609, or a different image from that. However, a unit for outputting information to the outside like the outer display units 615 is not a necessary constituent element of the technology which is disclosed in the specification.

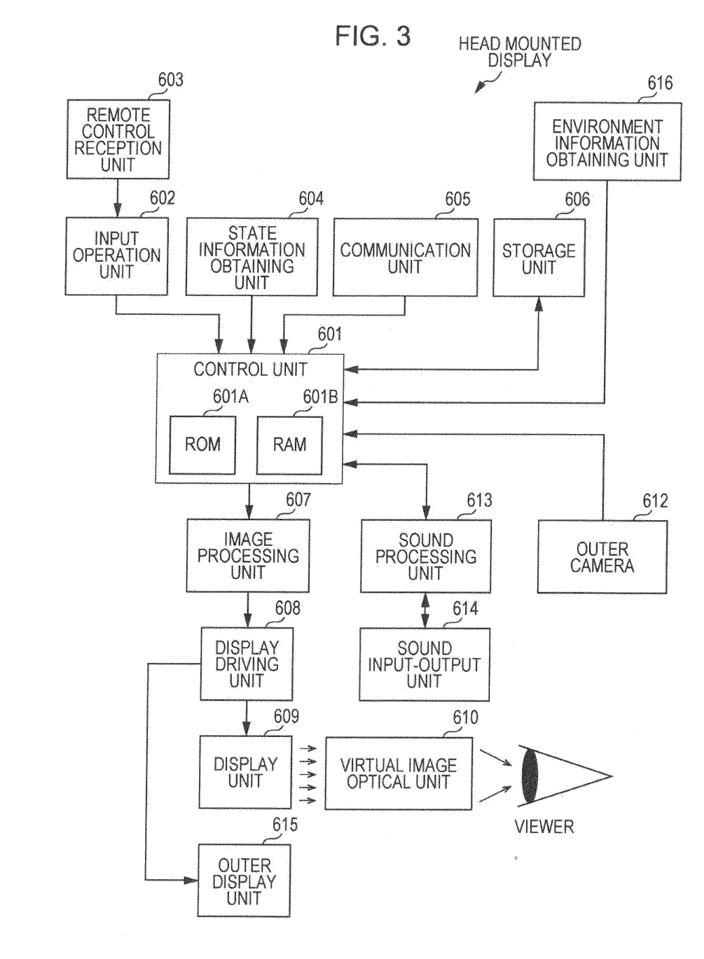

FIG. 3 illustrates an internal configuration example of the head mounted display.

A control unit 601 includes a Read Only Memory (ROM) 601A, and a Random Access Memory (RAM) 601B. A program code which is executed in the control unit 601, or various pieces of data are stored in the ROM 601A. The control unit 601 integrally controls the entire operation of the head mounted display including a display control of an image by executing a program which is downloaded to the RAM 601B. As a program or data which is stored in the ROM 601A, there is an image display control program, an image conversion processing program for performing image conversion which will be described later, a conversion table which is used in the image conversion processing, or the like.

An input operation unit 602 includes one or more operators such as a key, a button, a switch, or the like, with which a user performs an input operation, receives an instruction of the user though the operator, and outputs the instruction to the control unit 601. In addition the input operation unit 602 receives the instruction of the user which is formed of a remote control command received in a remote control reception unit 603, and outputs the instruction to the control unit 601.

A state information obtaining unit 604 is a functional module which obtains state information of the main body of the head mounted display, or of a user wearing the head mounted display. The state information obtaining unit 604 obtains a position of the head, posture, or information of the posture of a user, for example. In order to obtain information of the position and posture, the state information obtaining unit 604 includes a gyro sensor, an acceleration sensor, a Global Positioning System (GPS) sensor, a geomagnetic sensor, a Doppler sensor, an infrared sensor, a radio wave intensity sensor, or the like. In addition, the state information obtaining unit 604 includes a pressure sensor, a temperature sensor for detecting a body temperature or a temperature, a sweat sensor, a pulse sensor, a myoelectricity sensor, an eyes electric potential sensor, an electroencephalographic sensor, a respiratory rate sensor, or the like, in order to obtain information on a state of a user.

An environment information obtaining unit 616 is a functional module which obtains information relating to an environment which surrounds the main body of the head mounted display, or a user wearing the head mounted display. The environment information obtaining unit 616 may include various environment sensors including a sound sensor or an air volume sensor in order to detect environment information. It is possible to include the above described microphone, or the outer camera 612 in the environment sensor.

A communication unit 605 performs communication processing with an external device, modulation and demodulation processing, and encoding and decoding processing of a communication signal. As the external device, there is a contents reproduction device (Blu-ray Disc or DVD player) which supplies contents such as a moving image which a user views, or a streaming server. In addition, the control unit 601 sends out transmission data which is transmitted to the external device from the communication unit 605.

A configuration of the communication unit 605 is arbitrary. For example, it is possible to configure the communication unit 605 according to a communication method which is used in a transceiving operation with the external device which is a communication partner. The communication method may be either a wired method or a wireless method. Here, a communication standard can be an ultra-low power consumption wireless communication such as a Mobile High-definition Link (MHL), a Universal Serial Bus (USB), a High Definition Multimedia Interface (HDMI (registered trademark)), Wi-Fi (registered trademark), a Bluetooth (registered trademark) communication, a Bluetooth (registered trademark) Low Energy communication (BLE), or an ANT, and a mesh network which is standardized using IEEE802.11s, or the like. Alternatively, the communication unit 605 may be a cellular wireless transceiver which is operated according to a standard specification such as a Wideband Code Division Multiple Access (W-CDMA), and a Long Term Evolution (LTE), for example.

A storage unit 606 is a mass storage device which is configured of a Solid State Drive (SSD), or the like. The storage unit 606 stores an application program or various data items which are executed in the control unit 601. For example, contents which a user views are stored in the storage unit 606. In addition, an image which is photographed using the outer camera 612 is stored in the storage unit 606.

An image processing unit 607 further performs signal processing such as an image quality correction with respect to an image signal which is output from the control unit 601, and converts the signal into resolution corresponding to a screen of a display unit 609. In addition, a display driving unit 608 sequentially selects a pixel of the display unit 609 in each line, performs line sequential scanning, and supplies a pixel signal based on the image signal which was subject to the signal processing.

The display unit 609 includes a display panel which is configured of a micro display which is basically formed of a two-dimensional screen such as an organic Electro-Luminescence (EL) element, or a liquid crystal display, for example. A virtual image optical unit 610 projects a display image of the display unit 609 by enlarging thereof, and allows a user to view the image as an enlarged virtual image. In addition, as the display image which is output from the display unit 609, there are commercial contents which are supplied from a contents reproduction device (Blu ray disc or DVD player), or a streaming server, and a photographed image of the outer camera 612, or the like.

In an outer display unit 615, a display screen faces the outside of the head mounted display (direction opposite to the face of user who is wearing the device), and the specification of Japanese Patent Application No. 2012-200902 which has already been assigned to the applicant regarding a detailed configuration of the outer display unit 615 which can display an outer image for another user is disclosed.

A sound processing unit 613 further performs sound quality correction or sound amplification, and signal processing of an input sound signal, or the like, with respect to a sound signal which is output from the control unit 601. In addition, a sound input-output unit 614 outputs sound after being subjected to the sound processing to the outside, and inputs sound from the microphone (above described).

The head mounted display projects a display image of the display unit 609 such as the micro display with the virtual image optical unit 610 by enlarging the image, and forms the image on retinas of eyes of a user. A characteristic point of the embodiment is that a state in which an image which is displayed in a form desirable for a user is viewed, when viewing a display image, is simulated. The simulation of this state can be executed by performing image conversion processing with respect to an input image. The image conversion processing can be executed when the control unit 601 executes a predetermined program code, for example, however, it is also possible to mount a dedicated hardware into the control unit 601, or the image processing unit 607.

As an example of an image with a display form which is desirable for a user, there is an image which is projected onto a curved screen using a projector such as a screen in a movie theater. The original input image is viewed by a user as a two-dimensional plane, however, according to the embodiment, a state in which an input image can be viewed by a user as an image projected onto the curved screen using the projector is simulated by the image conversion processing.

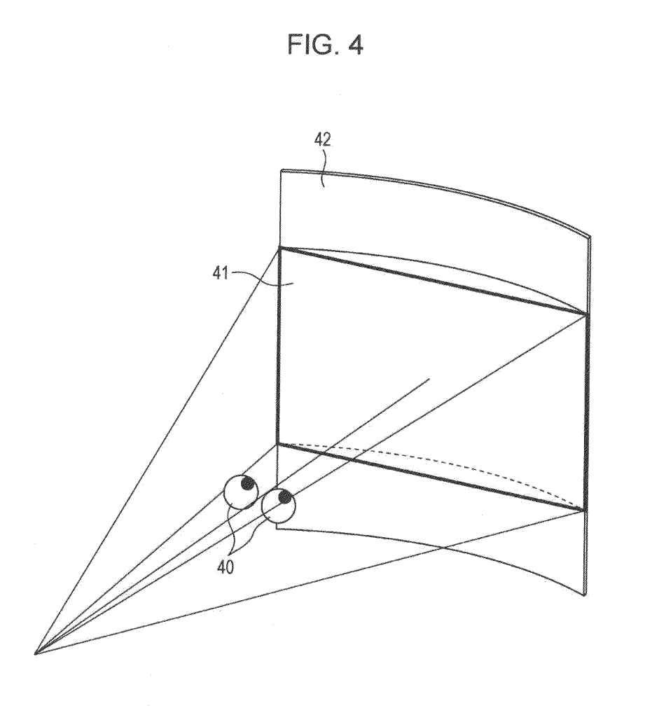

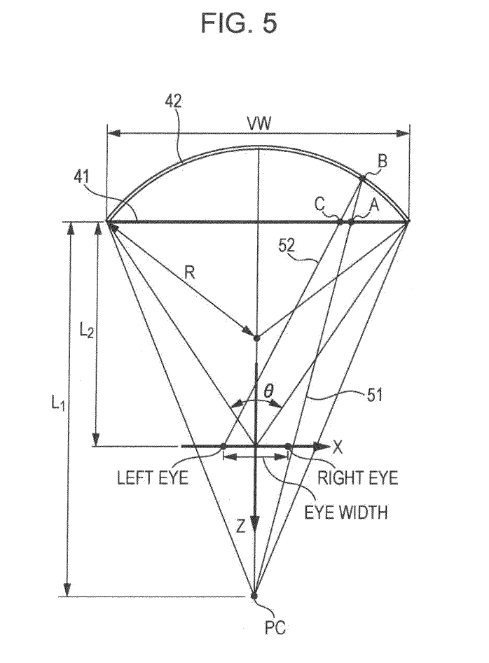

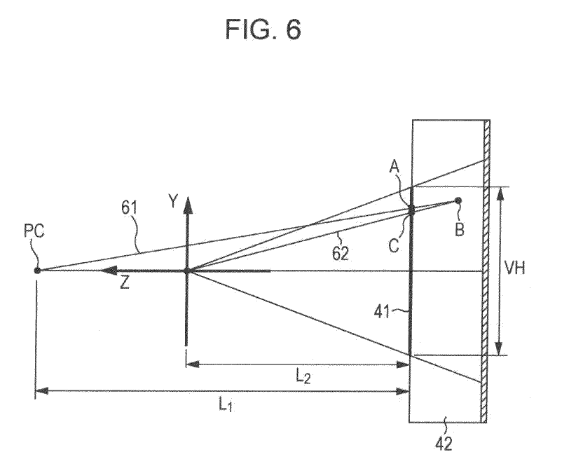

FIG. 4 is a diagram in which a state of a user who is viewing an image simulated as if the image is projected onto a curved screen using a projector is perspectively viewed. In addition, FIG. 5 illustrates a state in which the state in FIG. 4 is viewed from above, and FIG. 6 illustrates a state in which the state in FIG. 4 is viewed from the side. Here, in each figure, the horizontal direction is set to an X direction, the vertical direction is set to a Y direction, and a distance direction from the enlarged virtual image of the display image in the display unit 609 which is projected by being enlarged is set to a Z direction.

The virtual image optical unit 610 (not shown in FIGS. 4 to 6) projects the display image of the display unit 609 by enlarging thereof, and forms the image on the retinas of eyes of a user as an enlarged virtual image 41 which is present in front of user's eyes 40 by a distance L₂, and with the width VW and the height VH. A horizontal angle of view of the display image of the display unit 609 at this time is set to theta. Here, the enlarged virtual image 41 is not an image which is formed by simply projecting the input image with the virtual image optical unit 610 by enlarging thereof, and instead becomes a “virtual display panel” after being subjected to image conversion so that the image is viewed by a user as an image which is projected onto the curved screen 42 using a projector. That is, the image viewed by the user is a simulated virtual image of a curved image that would be displayed on a curved screen or panel 42, for instance. In examples illustrated in FIGS. 5 and 6, an image which is projected onto the curved screen 42 which is separated from a projector center (PC) of the projector by an irradiation distance L₁ is viewed by a user at a viewing position separated by distance L₂ (here, L₂<L₁) from the curves screen 42 is simulated on a virtual display panel 41. A radius of curvature of the curved screen 42 is set to R.

In FIG. 5, a relationship between a ray of light 51 which is radiated from the projector center PC of the projector and a gaze 52 of a user who is viewing the curved screen 42 will be focused on. The ray of light 51 passes through a point on the virtual display panel 41, and then is projected onto a point B on the curved screen 42. On the other hand, the gaze 52 which views the point B on the curved screen 42 with a left eye passes through a point C on the virtual display panel 41. Accordingly, when image information of a display pixel corresponding to a point A on the input image is moved in the X direction, or is converted so as to be displayed as a display pixel corresponding to the point C on an output image (enlarged virtual image 41 of display pixel of display unit 609), it looks as if an image which is projected onto the curved screen 42 from the projector center PC is viewed in the left eye of the user. That is, when the input image is subjected to image conversion so that the image information of each point (B) where the input image would be projected onto the curved screen 42 from the projector center PC of the projector is displayed at the point (C) at which the gaze of the user viewing the image information with the left eye reaches the virtual display panel 41, it is possible to simulate a state in which the user is viewing the image as if it was projected onto the curved screen using the projector (in X direction). In FIG. 5, a vector in which the point A is set to a starting point and the point C is set to an ending point is a “conversion vector” in the horizontal direction with respect to the display pixel corresponding to the point A (here, horizontal component when performing integral conversion using two-dimensional conversion vector without performing V/H separation (which will be described later)).

Similarly, in FIG. 6, a ray of light 61 which is radiated from the projector center PC of the projector will be focused on. The ray of light 61 is projected onto the point B on the curved screen 42 after passing through the point A on the virtual display panel 41. On the other hand, a gaze 62 which views the point B on the curved screen 42 at a position separated by the distance L₂ passes through the point C on the virtual display panel 41. Accordingly, when image information of a display pixel corresponding to the point A on the input image is moved in the Y direction, or is converted so as to be displayed as a display pixel corresponding to the point C on the output image (enlarged virtual image 41 of display pixel of display unit 609), it looks as if an image which is projected onto the curved screen 42 from the projector center PC is viewed, in the left eye of the user. That is, when the input image is subjected to image conversion so that the image information of each point (B) when the input image is projected onto the curved screen 42 using the projector is displayed at the point (C) at which the gaze of the user viewing the image information with the left eye reaches the virtual display panel 41, it is possible to simulate a state in which the user is viewing the image which is projected onto the curved screen using the projector (also in Y direction). In FIG. 6, a vector in which the point A is set to a starting point and the point C is set to an ending point is a “conversion vector” in the vertical direction with respect to the display pixel corresponding to the point A (here, vertical component when performing integral conversion using two-dimensional conversion vector without performing V/H separation (which will be described later)).

The conversion vectors in the horizontal direction and vertical direction can be generated based on light ray tracing data which is obtained by an optical simulation which traces a ray of light output from each pixel of the display unit 609, for example. In the conversion vector, a correlation between the pixel position on the original input image and the pixel position on the presented image which is output from the display unit 609 is described.

In addition, though it is not illustrated, it is possible to simulate a state in which an image which is projected onto the curved screen 42 using the projector is viewed, by moving image information, or performing a conversion of image information in each pixel of the display unit 609 with respect to the right eye, using an image conversion method which is similar to those in FIGS. 5 and 6, and is horizontally symmetrical.

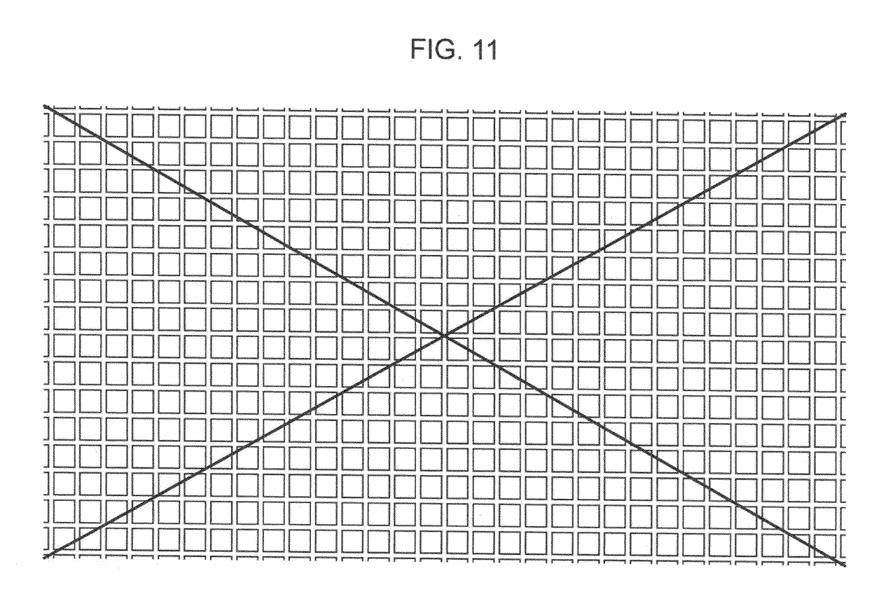

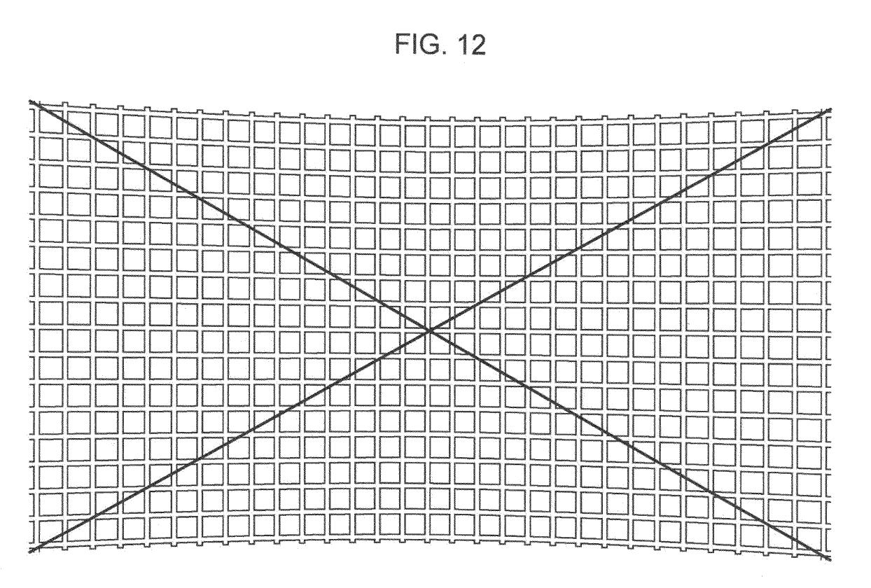

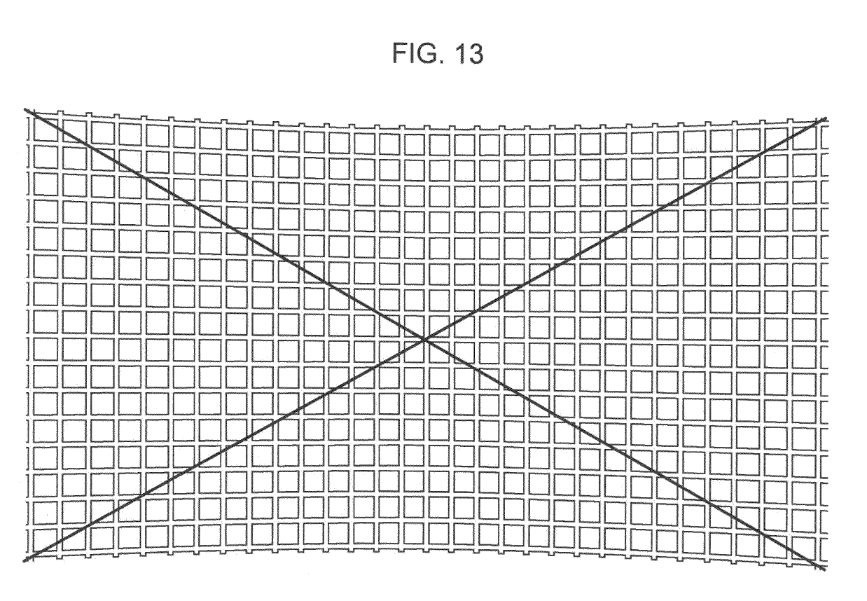

FIGS. 12 and 13 exemplify respective images in which the input image illustrated in FIG. 11 is converted into images which are projected onto the curved screen 42 using the projector, respectively, and can be viewed in each of the left eye and right eye of the user.

The input image which is assumed in FIG. 11 is formed by a check pattern in which a plurality of parallel lines which are uniformly arranged in the horizontal direction and vertical direction, respectively, are combined. When assuming that there is no image distortion which is caused by optical distortion in the virtual image optical unit 610, if the input image illustrated in FIG. 11 is displayed on the display unit 609 as is, the check pattern of the input image is displayed as parallel lines without distortion of the horizontal and vertical lines, and at even intervals on the virtual display panel 41. Accordingly, the left and right eyes of the user are in a state of viewing the input image illustrated in FIG. 11 as is, on the virtual display panel 41.

The image illustrated in FIG. 12 is an image in which the input image illustrated in FIG. 11 is subject to the image conversion so that the image information in each point when the input image illustrated in FIG. 11 is projected onto the curved screen 42 using the projector is displayed at the point at which the gaze of the user who is viewing with the left eye reaches the virtual display panel 41. When the conversion image illustrated in FIG. 12 is displayed on the display panel 404L for left eye, it is possible to simulate a state in which the user is viewing the image which is formed when the input image illustrated in FIG. 11 is projected onto the curved screen 42 using the projector with the left eye.

Similarly, the image illustrated in FIG. 13 is an image in which the input image illustrated in FIG. 11 is subjected to the image conversion so that the image information in each point when the input image illustrated in FIG. 1 is projected onto the curved screen 42 using the projector is displayed at the point at which the gaze of the user who is viewing with the right eye reaches the virtual display panel 41. When the conversion image illustrated in FIG. 13 is displayed on the display panel 404R for right eye, it is possible to simulate a state in which the user is viewing the image which is formed when the input image illustrated in FIG. 11 is projected onto the curved screen 42 using the projector with the right eye. The conversion image illustrated in FIG. 12, and the conversion image illustrated in FIG. 13 are recognized as images which are horizontally symmetric.

In addition, as another example of an image with a display form which is desirable for a user, there is an image which is presented on the curved panel. The original input image is viewed by a user as a two-dimensional plane, however, according to the embodiment, a state in which the input image can be viewed by a user as an image which is presented on the curved panel due to image conversion processing is simulated.

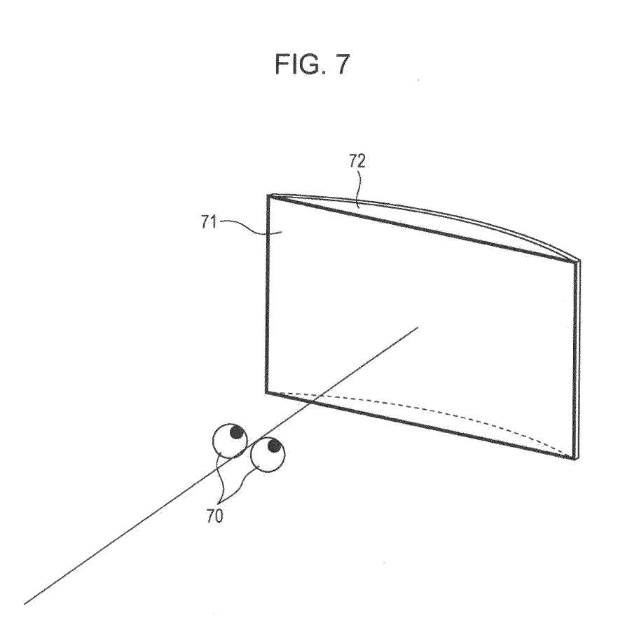

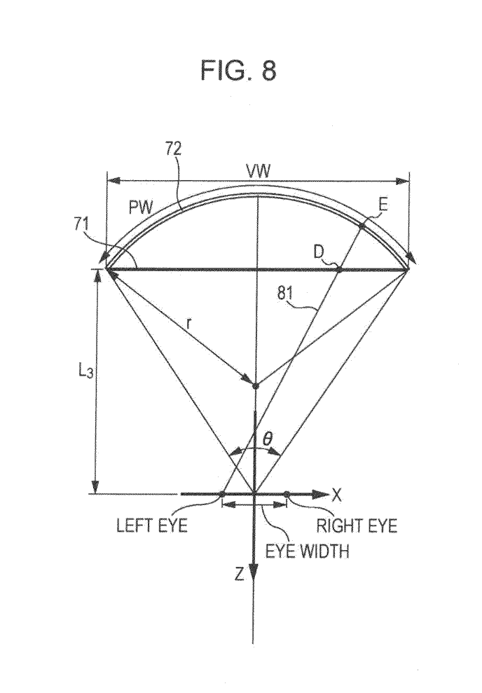

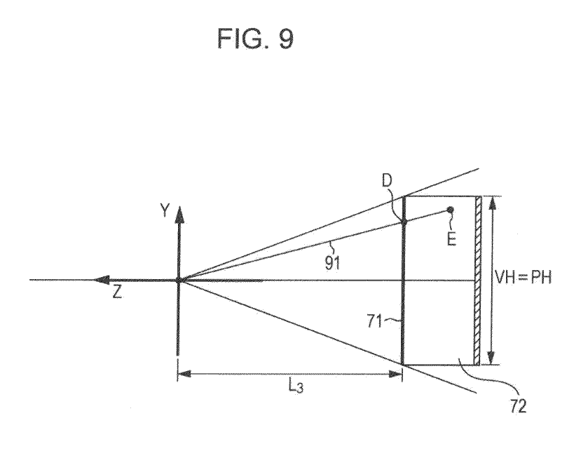

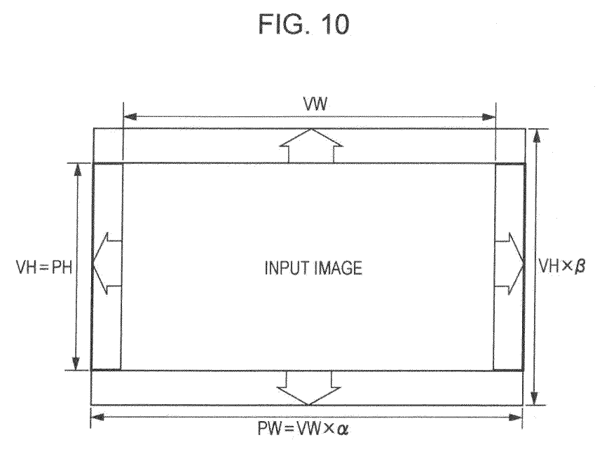

FIG. 7 is a perspective view which illustrates a state in which a user is viewing an image which is simulated as if the image is presented on the curved panel. The presented image on a curved panel 72 is an image which is formed by enlarging an input image in the horizontal direction and vertical direction, and presenting thereof (which will be described later, and refer to FIG. 10). In addition, FIG. 8 illustrates a state in which the state in FIG. 7 is viewed from above. FIG. 9 illustrates a state in which the state in FIG. 7 as viewed from the side. Here, the horizontal direction is set to an X direction, the vertical direction is set to a Y direction, and a distance direction from a projecting plane of the display pixel of the display unit 609 is set to a Z direction.

The virtual image optical unit 610 (not shown in FIGS. 8 and 9) projects the display image on the display unit 609 by enlarging thereof, and forms the image on retinas of eyes of a user as an enlarged virtual image 71 with the width VW and the height VH which is present in front of user's eyes 70 by a distance L₃. A horizontal angle of view of the display pixel of the display unit 609 at this time is set to theta. Here, the enlarged virtual image 71 is not an image which is formed by simply projecting the input image onto the virtual image optical unit 610 by enlarging thereof, and becomes a “virtual display panel” after being subjected to image conversion so that the image is viewed by a user as an image which is presented on the curved panel 72. In examples illustrated in FIGS. 8 and 9, a state in which an image which is presented on the curved panel 72 of which radius of curvature is r is viewed from a viewing position of the distance L₃ from the curved panel 72 is simulated on a virtual display panel 71.

In FIG. 8, a gaze 81 of the left eye of a user who is viewing the curved panel 72 will be focused. The gaze 81 passes through a point D on the virtual display panel 71, and reaches a point E on the curved panel 72. Accordingly, when image information to be displayed at the point E of the curved panel 72 is moved in the X direction, or is converted so as to be displayed as a display pixel corresponding to the point D on the virtual display panel 71, it looks as if a presented image on the curved panel 72 is viewed in the left eye of the user. That is, when the input image is subjected to image conversion so that image information of each point (E) when presenting the input image on the curved panel 72 is displayed at the point (D) at which the gaze of the user who is viewing with the left eye reaches the virtual display panel 71, it is possible to simulate a state in which the user is viewing the image presented on the curved panel 72 (in X direction). A vector in which the point E is set to a starting point and the point D is set to an ending point is a “conversion vector” in the horizontal direction with respect to the display pixel corresponding to the point E (here, horizontal component when performing integral conversion using two-dimensional conversion vector without performing V/H separation (which will be described later)).

Similarly, a gaze 91 of a user who is viewing the curved panel 72 will be focused in FIG. 9. The gaze 91 passes through a point D on the virtual display panel 71, and reaches a point E on the curved panel 72. Accordingly, when image information to be displayed at the point E of the curved panel 72 is moved in the Y direction, or is converted so as to be displayed as a display pixel corresponding to the point D on the virtual display panel 71, it looks as if a presented image on the curved panel 72 is viewed from the eye of the user. That is, when the input image is subject to image conversion so that image information of each point when presenting the input image on the curved panel 72 is displayed at the point at which the gaze of the user who is viewing with the left eye reaches the virtual display panel 41, it is possible to simulate a state in which the user is viewing the image presented on the curved panel (also in Y direction). In FIG. 9, a vector in which the point E is set to the starting point and the point D is set to the ending point is a “conversion vector” in the vertical direction with respect to the display pixel corresponding to the point E (here, vertical component when performing integral conversion using two-dimensional conversion vector without performing V/H separation (which will be described later)).

The conversion vectors in the horizontal direction and vertical direction can be generated based on light ray tracing data which is obtained by an optical simulation which traces a ray of light output from each pixel of the display unit 609, for example. In the conversion vector, a correlation between the pixel position on the original input image and the pixel position on the presented image which is output from the display unit 609 is described.

In addition, though it is not illustrated, it is possible to simulate a state in which an image which is presented on the curved panel 72 is viewed, by moving image information, or performing a conversion of image information in each display pixel of the display unit 609 with respect to the right eye as well, using an image conversion method which is similar to those in FIGS. 8 and 9, and is horizontally symmetrical.

A relationship between the input image and the image which is presented by the curved panel 72 will be described with reference to FIG. 10. The presented image on the curved panel 72 is an image which is formed by enlarging the input image using magnification ratios of alpha and beta in the X direction and Y direction, respectively. There is no linkage between the magnification ratio alpha in the X direction and the magnification ratio beta in the Y direction. For example, when the input image is a horizontally long screen like a cinemascope screen, the magnification ratio beta in the vertical direction becomes larger than the magnification ratio alpha in the horizontal direction in order to push upper and lower black bands which are generated when presenting the image on the curved panel 72 to the outside of an effective display region as possible in hardware manner. On the other hand, the enlarged virtual image (that is, virtual display panel) 71 which is projected onto the virtual image optical unit 610 by being enlarged is an enlarged image which is formed by enlarging the input image in the X and Y directions using the same magnification ratio, and has a similar shape to the input image (here, for simple description, image distortion such as optical distortion which occurs in virtual image optical unit 610 is neglected).

In FIG. 10, a size of the virtual display panel 71 which has the similar shape to the input image has the width of VW and the height of VH. In contrast to this, when the curved panel 72 is set to an arc with a radius of r, and a central angle of gamma, the transverse width PW becomes r*gamma, however, it is clearly understood that the transverse width is longer than VW from FIG. 8. The input image is enlarged in the Y direction, however, in the illustrated example, the image is denoted by PW=VW*alpha (here, alpha>1). On the other hand, in the Y direction, the input image is enlarged by beta times so that the upper and lower black bands are pushed to the outside of the height VH of the effective display region when the input image is enlarged by alpha times in the horizontal direction as described above. The height PH of the virtual display panel 71 may be the same as the height VH of the virtual display panel 71 in which the upper and lower black bands are pushed to the outside.

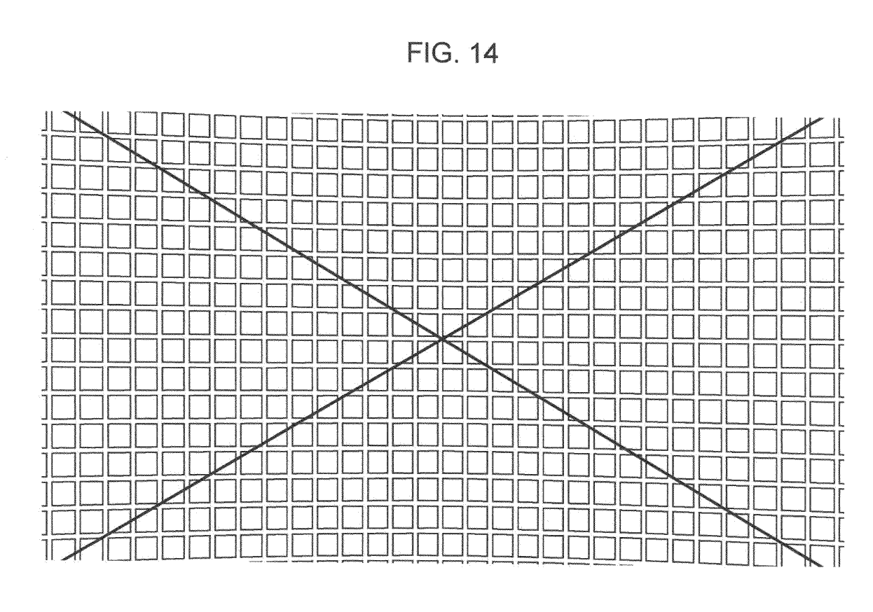

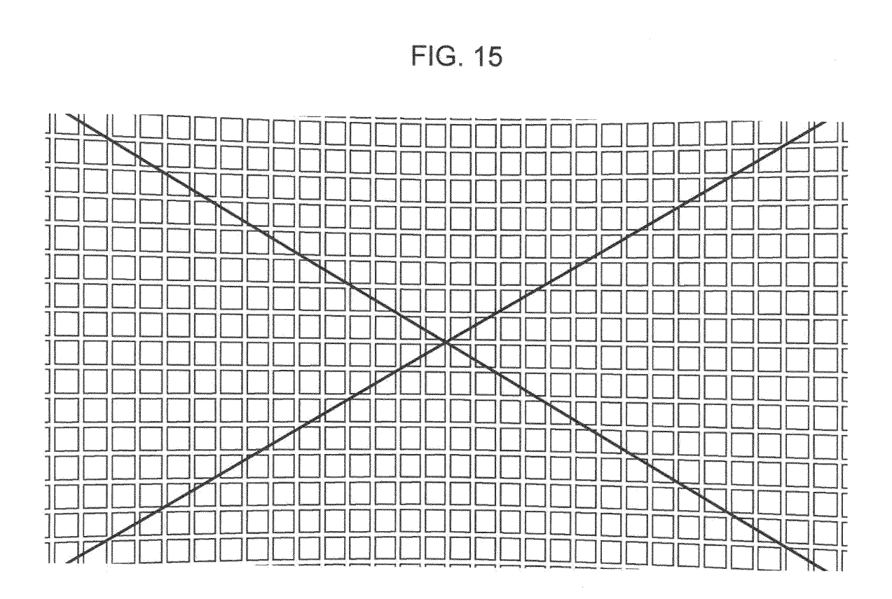

FIGS. 14 and 15 respectively exemplify images in which the input image illustrated in FIG. 11 which is formed by the check pattern (as described above) is converted so that a state is simulated in which the image which is presented on the curved panel is viewed in each of the left eye and right eye of the user.

When the input image illustrated in FIG. 1 is displayed on the display unit 609, the input image is displayed on the virtual display panel 41 as is. Accordingly, the left and right eyes of the user are in a state of viewing the input image which is presented on the virtual display panel 41 (as described above). In contrast to this, the image illustrated in FIG. 14 is an image which is formed by performing image conversion with respect to the input image illustrated in FIG. 11 so that image information of each point when the input image illustrated in FIG. 11 is presented on the curved panel 72 is displayed at the point at which the gaze of the user viewing with the left eye reaches the virtual display panel 41. When the conversion image illustrated in FIG. 14 is displayed on the display unit 609 for left eye, it is possible to simulate a state in which the input image illustrated in FIG. 10 which is presented on the curved panel 72 is viewed by the user with the left eye.

Similarly, the image illustrated in FIG. 15 is an image which is formed by performing image conversion with respect to the input image illustrated in FIG. 11 so that image information of each point when the input image illustrated in FIG. 11 is presented on the curved panel 72 is displayed at the point at which the gaze of the user viewing with the right eye reaches the virtual display panel 41. When the conversion image illustrated in FIG. 15 is displayed on the display unit 609 for right eye, it is possible to simulate a state in which the input image illustrated in FIG. 10 which is presented on the curved panel 72 is viewed by the user with the right eye. It is understood that the conversion image illustrated in FIG. 14 and the conversion image illustrated in FIG. 15 are horizontally symmetric.

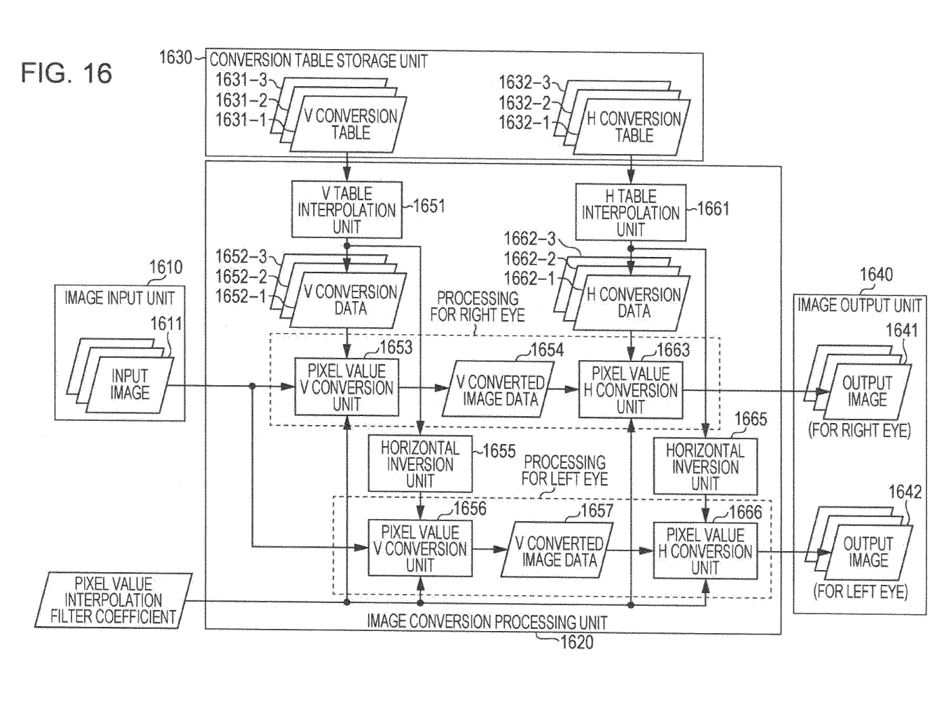

FIG. 16 illustrates a functional block diagram for performing image conversion so that an input image is viewed as an image which is displayed in another form. As the display in another form, as described above, there is a state in which an image which is projected onto the curved screen using the projector is viewed (refer to FIGS. 4 to 6), a state in which an image presented on the curved panel is viewed (refer to FIGS. 7 to 9), or the like.

An illustrated image conversion functional unit 1600 includes an image input unit 1610 which inputs an image (input image) as a processing target, an image conversion processing unit 1620 which performs image conversion with respect to an input image so that the image is viewed as an image displayed in another form, a conversion table storage unit 1630 which stores a conversion table used in the image conversion, and an image output unit 1640 which outputs the converted image.

The image input unit 1610 corresponds to the communication unit 605 which receives contents such as a moving image which is viewed by a user from a content reproduction device, a streaming server, or the like, for example, or the outer camera 612 which supplies a photographed image, or the like, and inputs an input image for right eye and an input image for left eye, respectively, from the content supply sources.

The image conversion processing unit 1620 performs image conversion with respect to the input image from the image input unit 1610 so that the image is viewed as an image which is displayed in another form. The image conversion processing unit 1620 is configured as dedicated hardware which is mounted into the control unit 601, or the image processing unit 607, for example. Alternatively, the image conversion processing unit 1620 can also be realized as an image conversion processing program which is executed by the control unit 601. Hereinafter, for convenience, the image conversion processing unit 1620 will be described as the mounted dedicated hardware.

The conversion table storage unit 1630 is the ROM 601A, or an internal ROM (not shown) of the image processing unit 607, and stores a conversion table in which a conversion vector of each display pixel of an input image which is used when performing image conversion so that the input image is viewed as an image displayed in another form is described. In the conversion vector, a correlation between a pixel position on the original input image and a pixel position on the presented image which is output from the display unit 609 is described. The conversion vector can be generated based on light ray tracing data which is obtained by an optical simulation which traces a ray of light output from each pixel of the display unit 609, for example.

In addition, according to the embodiment, in order to suppress a storage capacity of the conversion table, only a conversion vector of a display pixel of a representative point which is discretely arranged, not all of display pixels, and a conversion vector of a display pixel except for the representative point are interpolated by a V table interpolation unit 1651 and an H table interpolation unit 1661, using a conversion vector of a neighboring representative point. Detailed interpolation processing by the V table interpolation unit 1651 and an H table interpolation unit 1661 will be described later. In addition, according to the embodiment, the image conversion is performed by being separated into the vertical direction and horizontal direction, by including two types of a vertical direction conversion table (V conversion table) 1631, and a horizontal direction conversion table (H conversion table) by separating the conversion vector into the horizontal direction and vertical direction (that is, V/H separation).

The image output unit 1640 corresponds to the display panel of the display unit 609, and displays an output image after being subject to image conversion (viewed as if image is displayed in another form). The technology which is disclosed in the specification can also be applied to a monocular head mounted display, however, in the descriptions below, the technology is applied to a binocular head mounted display, and the image output unit 1640 outputs output images 1641 and 1642 in each of left and right eyes.

A functional configuration of the image conversion processing unit 1620 will be described in more detail.

The image conversion processing unit 1620 performs image conversion with respect to an input image from the image input unit 1610 so as to be viewed as an image which is displayed in another form by a user. One characteristic point in the embodiment is that the image conversion processing unit 1620 is configured so that conversion processing in the vertical direction and conversion processing in the horizontal direction are performed using V/H separation. It is possible to reduce a calculation load by performing conversion processing separately in the vertical direction and horizontal direction in this manner. For this reason, the conversion table storage unit 1630 maintains two types of a conversion table in the vertical direction (V conversion table) 1631, and a conversion table in the horizontal direction (H conversion table) 1632. In other words, a pair of V conversion table 1631-1 and H conversion table 1632-1, . . . are maintained in each display form (when referring to above described example, a pair of V conversion table 1631-1 and H conversion table 1632-1, . . . are maintained in each of form of converting into image which is projected onto curved screen using projector, and form of image which is presented on curved panel).

In addition, as another characteristic point of the embodiment, it is possible to reduce, by maintaining the conversion tables of 1631 and 1632 in the vertical direction and horizontal direction only for one image for the right eye (or image for the left eye), by paying attention to the fact that the image conversion is performed in a horizontally symmetrical manner. That is, only the conversion tables of 1631 and 1632 for the right eye image are maintained, the V table interpolation unit 1651 and the H table interpolation unit 1661 interpolate conversion information of all of pixels except for the representative point, and then horizontal inversion units 1655 and 1665 cause a V conversion vector and an H conversion vector of all pixels for right eye to be horizontally inverted, respectively, thereby obtaining conversion information for left eye.

When the V conversion table 1631 in a desired display form is extracted from the conversion table storage unit 1630, the V table interpolation unit 1651 interpolates a conversion vector in the vertical direction of a display pixel except for the representative point, and obtains V conversion data items 1652 which are formed of V conversion vectors for right eye of all pixels. In addition, when the H conversion table 1632 in a desired display form is extracted from the conversion table storage unit 1630, the H table interpolation unit 1661 interpolates an H conversion vector of a display pixel except for the representative point, and obtains H conversion data items 1662 which are formed of H conversion vectors for right eye of all pixels.

In addition, when an input image 1611 for right eye is input from the image input unit 1610, a pixel value V conversion unit 1653 performs conversion processing in the vertical direction first, by sequentially applying a corresponding V conversion vector in the V conversion data items 1652 with respect to each pixel, and obtains V converted image data for right eye 1654.

Subsequently, a pixel value H conversion unit 1663 performs conversion processing in the vertical direction by sequentially applying a corresponding H conversion vector in the H conversion data items 1662 with respect to each pixel of the V converted image data 1654, and obtains an output image for right eye 1641 in which the conversion processing in the vertical direction and horizontal direction have been done. The output image 1641 is presented on the display panel for the right eye of the display unit 609.

The horizontal inversion unit 1655 obtains the V conversion data items which are formed of the V conversion vector for left eye of all pixels by performing a horizontal inversion of the V conversion data items 1652. In addition, when an input image for the left eye is input from the image input unit 1610, the pixel value V conversion unit 1656 performs conversion processing in the vertical direction, by sequentially applying a corresponding V conversion vector for the left eye with respect to each pixel, and obtains V converted image data for left eye 1657.

In addition, the horizontal inversion unit 1665 performs the horizontal inversion with respect to the H conversion data items 1662, and obtains H conversion data items which are formed of the H conversion vector for left eye of all pixels. The pixel value H conversion unit 1666 performs the conversion processing in the horizontal direction by sequentially applying a corresponding H conversion vector for the left eye with respect to each pixel of the V converted image data 1657, and obtains the output image for left eye 1642 in which the conversion processing in the vertical direction and horizontal direction have been done. The output image 1642 is presented on the display panel for the left eye of the display unit 609.

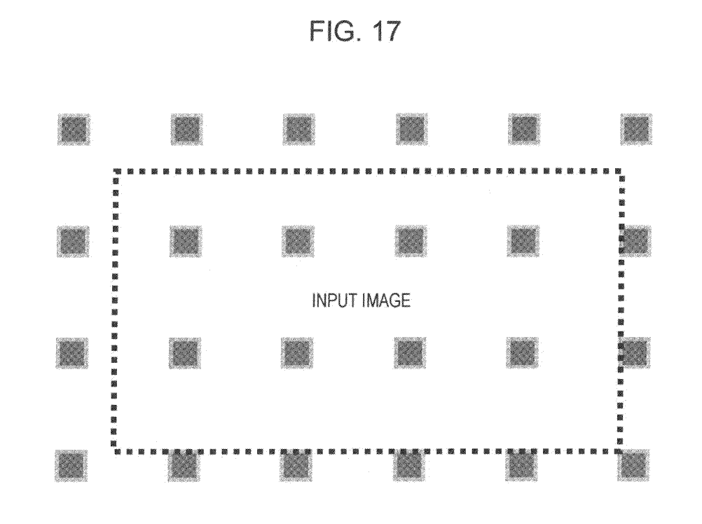

FIG. 17 schematically illustrates a state in which the conversion table storage unit 1630 maintains the conversion vector of only the representative point. In FIG. 17, a portion denoted by a dark gray color corresponds to the representative point, however, in the illustrated example, the representative point is arranged at even intervals in each of the horizontal direction and vertical direction. The V conversion table 1631 maintains the conversion vector in the vertical direction only for the pixel of the representative point, and the H conversion table 1632 maintains the conversion vector in the horizontal direction only for the pixel of the representative point.

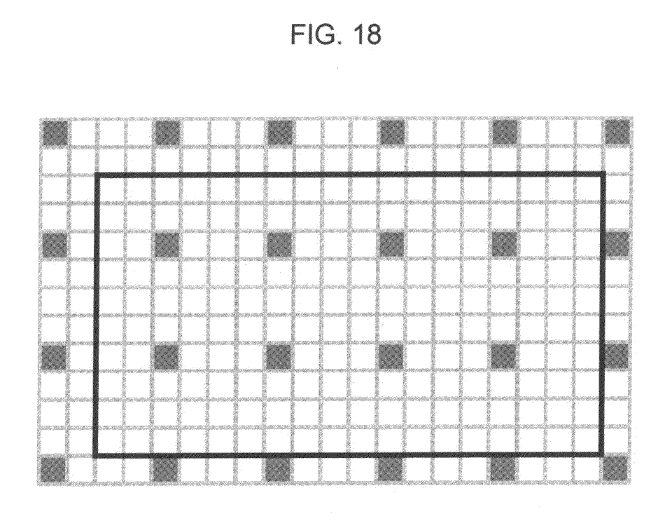

As described above, the V table interpolation unit 1651 and the H table interpolation unit 1661 interpolate the conversion vector of the display pixel except for the representative point from the conversion vector of the representative point. FIG. 18 schematically illustrates a state in which the conversion vector of the display pixel except for the representative point is obtained by interpolation processing of the V table interpolation unit 1651 and the H table interpolation unit 1661. In FIG. 18, a pixel of which the conversion vector is interpolated is denoted by a light gray color.

Subsequently, a process of interpolating the conversion vector of the display pixel except for the representative point in the V table interpolation unit 1651 and the H table interpolation unit 1661 will be described.

As described above, one characteristic of the embodiment is that the conversion processing in the vertical direction and the conversion processing in the horizontal direction are performed using the V/H separation, and for this reason, the conversion table is configured by combining the conversion table in the vertical direction (V conversion table) 1631 and the conversion table in the horizontal direction (H conversion table) 1632.

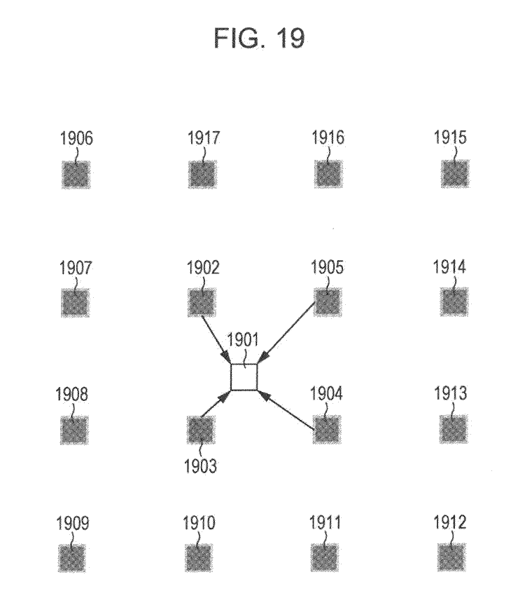

FIG. 19 exemplifies a method of interpolation processing of the conversion table when the separation into the horizontal direction and vertical direction is not performed. In FIG. 19, a two-dimensional conversion vector having components of each of horizontal direction and vertical direction is maintained in the conversion table at each of representative points 1902 to 1907 which are denoted by a gray color. A conversion vector of a pixel 1901 except for the representative point can be calculated, for example, using four neighboring representative points of 1902 to 1905, that is, using a two-dimensional weighted sum of pieces of information of four taps. As a matter of course, the conversion vector of the pixel 1901 may be obtained using the two-dimensional weighted sum from pieces of information of sixteen taps of sixteen representative points of 1902 to 1917 in the vicinity.

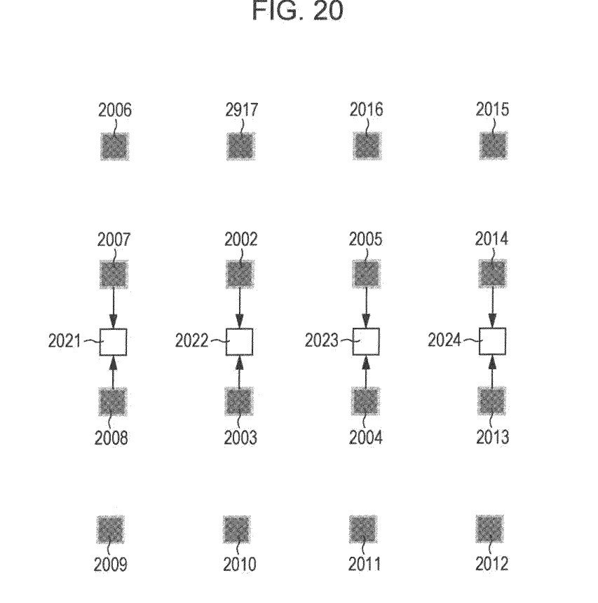

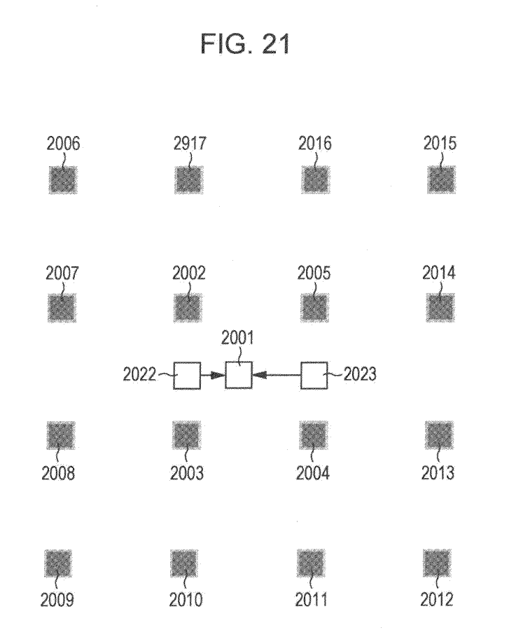

On the other hand, FIGS. 20 and 21 exemplify a method of interpolation processing of the conversion table when the V/H separation in the horizontal direction and vertical direction is performed. In each of FIGS. 20 and 21, V conversion vectors of representative points 2002 to 2017 which are denoted by the gray color are stored in the V conversion table 1631, and H conversion vectors are stored in the H conversion table 1632.

The V table interpolation unit 1651 and the H table interpolation unit 1661 respectively perform interpolation processing of each of conversion tables 1631 and 1632 in two steps of interpolation in the vertical direction (V interpolation) and interpolation in the horizontal direction (H interpolation). First, the V interpolation of the V conversion table 1631 will be described with reference to FIG. 20. For pixels 2021 to 2024 which are interposed between representative points in the vertical direction, weights of representative points 2007 and 2008, representative points 2002 and 2003, representative points 2005 and 2004, and representative points 2014 and 2013 which are neighboring in the vertical direction are calculated, and accordingly, it is possible to interpolate the V conversion vector using one dimensional weighted sum of the V conversion vector of each representative point (as a matter of course, the number of taps may be increased). In addition, for a pixel 2001 which is not interposed between representative points in the vertical direction, as illustrated in FIG. 21, H interpolation, that is, a calculation of weights of V interpolated neighboring pixels 2022 and 2023 which are in the same horizontal position is performed, and accordingly, it is possible to interpolate the V conversion vector using the one dimensional weighted sum of the V vector (as a matter of course, the number of taps may be increased). It is possible to perform the interpolation of the conversion table using the one dimensional weighted sum by performing the V/H separation of two steps which are the V interpolation and the H interpolation in this manner, and to reduce throughput. In addition, as illustrated in FIGS. 20 and 21, the H table interpolation unit 1661 can perform the table interpolation by performing the interpolation processing of the H conversion table 1632 in two steps of the interpolation processing in the vertical direction (V interpolation) and the interpolation processing in the horizontal direction (H interpolation).

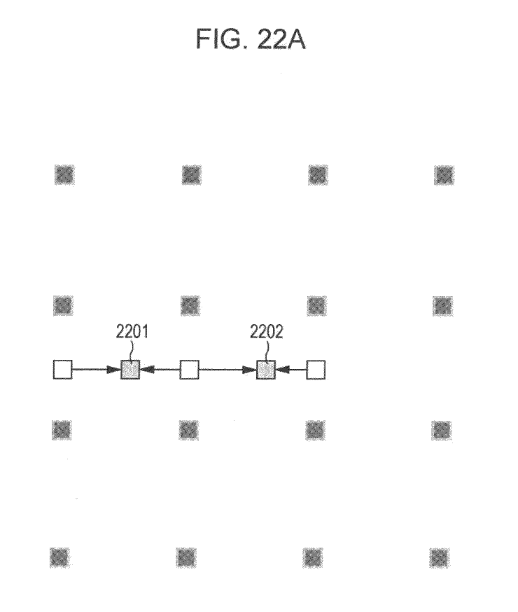

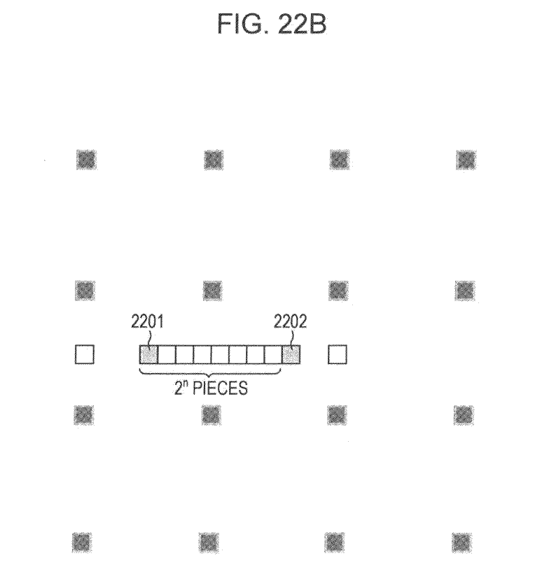

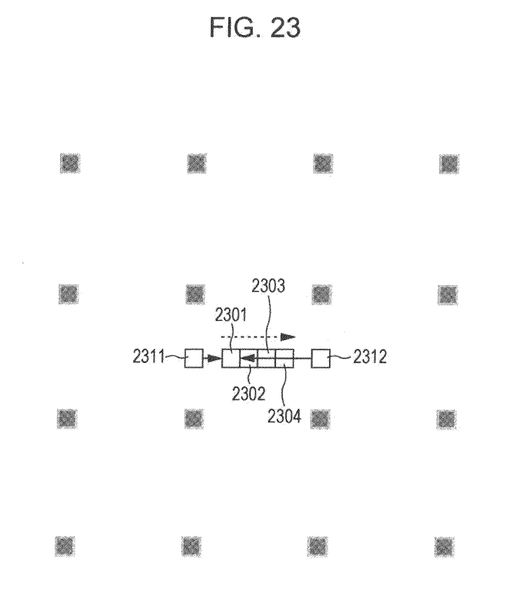

In addition. FIGS. 22A and 22B illustrate a method in which the V table interpolation unit 1651 and the H table interpolation unit 1661 reduce interpolation processing of the conversion vector illustrated in FIG. 21 in the horizontal direction (H interpolation). For a comparison, a method of interpolating the conversion vector by calculating a weight in each interpolation position at each time is illustrated in FIG. 23. In the example illustrated in FIG. 23, conversion vectors of representative points 2301 to 2304 which are interposed between V interpolated neighboring pixels 2311 and 2312 are calculated by calculating weights corresponding to each interpolation position at each time, and calculating a weighted sum. In contrast to this, in the examples illustrated in FIGS. 22A and 22B, first, as illustrated in FIG. 22A, when representative positions 2201 and 2202 are set in pixel intervals as an exponent of 2 (2ⁿ) (n=3 in illustrated example), the conversion vector is interpolated using a one dimensional weighted sum of two steps in the vertical direction and horizontal direction, according to the method illustrated in FIGS. 20 and 21 with respect to the representative positions 2201 and 2202. In addition, for pixels between the representative positions 2201 and 2202, the conversion vector is interpolated using two taps weighted sum at even intervals. That is, as illustrated in FIG. 22B, the conversion vector of the pixel between the representative positions 2201 and 2202 is interpolated using two taps weighted sum at even intervals. The two taps weighted sum can be executed only using bit shift. It is possible to further reduce the throughput by applying the interpolation methods illustrated in FIGS. 20 and 21 are applied to the pixel of the representative position, and using hybrid interpolation in which the interpolation methods illustrated in FIGS. 22A and 22B are applied to the pixels between the representative positions.

Subsequently, a process of performing image conversion in the horizontal direction in the pixel value H conversion unit 1663, after performing a conversion of an input image in the vertical direction in the pixel value V conversion unit 1653 will be described. Here, only an image for the right eye will be described, however, it may be understood that the same process is performed by the pixel value V conversion unit 1656 and the pixel value H conversion unit 1666 with respect to an image for the left eye, as well.

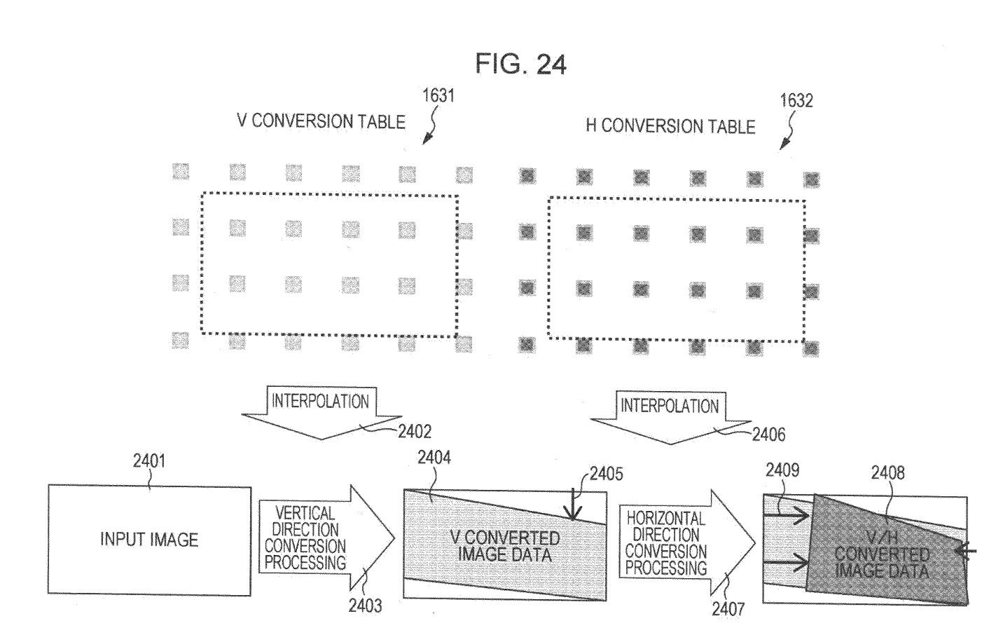

FIG. 24 schematically illustrates a processing order of performing image conversion in the horizontal direction in the pixel value H conversion unit 1663, after performing conversion in the vertical direction of an input image in the pixel value V conversion unit 1653, when performing the image conversion with respect to the input image. It is possible to reduce a processing load since the process becomes one dimensional processing by performing the conversion processing in the vertical direction and the conversion processing in the horizontal direction using the V/H separation.

First, the pixel value V conversion unit 1653 performs conversion processing 2403 in the vertical direction which is one dimensional, using V conversion data 1652 which is interpolated (2402) from the V conversion table 1631 with respect to an input image 2401, and obtains V converted image data 2404. The V converted image data 2404 is subject to a conversion 2405 in the vertical direction with respect to the input image 2401.

Subsequently, the pixel value H conversion unit 1663 performs conversion processing 2407 in the horizontal direction which is one dimensional using H conversion data which is interpolated (2406) from the H conversion table 1632 with respect to the V converted image data 2404, and obtains V/H converted image data 2408. The V/H converted image data 2408 is data which is further subject to conversion 2409 in the horizontal direction with respect to the V converted image data 2404.

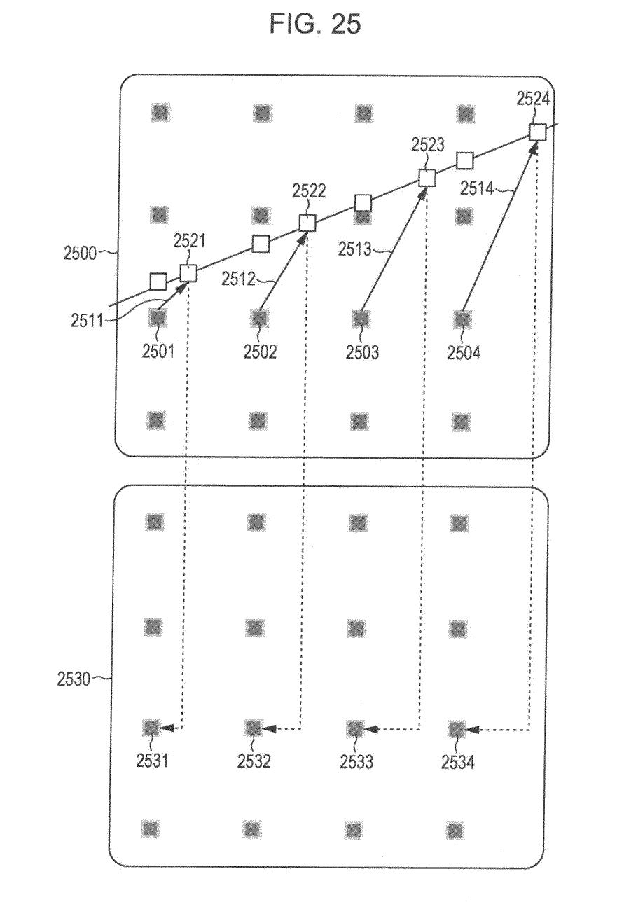

FIG. 25 illustrates an example in which two-dimensional image conversion processing is performed. When pixel positions 2521 to 2524 are obtained by applying two-dimensional conversion vectors 2511 to 2514 to each of pixels 2501 to 2504 of an input image 2500, respectively, an output image 2530 is obtained by writing image information in each of pixel positions 2521 to 2524 in each of corresponding pixels 2531 to 2534. In addition, a position in the vertical direction of a point crossing the pixel position in the horizontal direction of a curved line which connects pixel positions 2521 to 2524 corresponds to the “conversion vector” in the vertical direction which are illustrated in FIGS. 6 and 9. In addition, a distance in the horizontal direction from the cross point to the curved line corresponds to the “conversion vector” in the horizontal direction illustrated in FIGS. 5 and 8. According to the embodiment, the H conversion vector and the V conversion vector for performing the image conversion processing using the V/H separation are different from the conversion vector in the horizontal direction and the conversion vector in the vertical direction when the two-dimensional conversion processing is integrally performed without using the V/H separation. It is necessary to recalculate the H conversion vector and the V conversion vector for V/H separation, based on the conversion vector in the horizontal direction, and the conversion vector in the vertical direction.

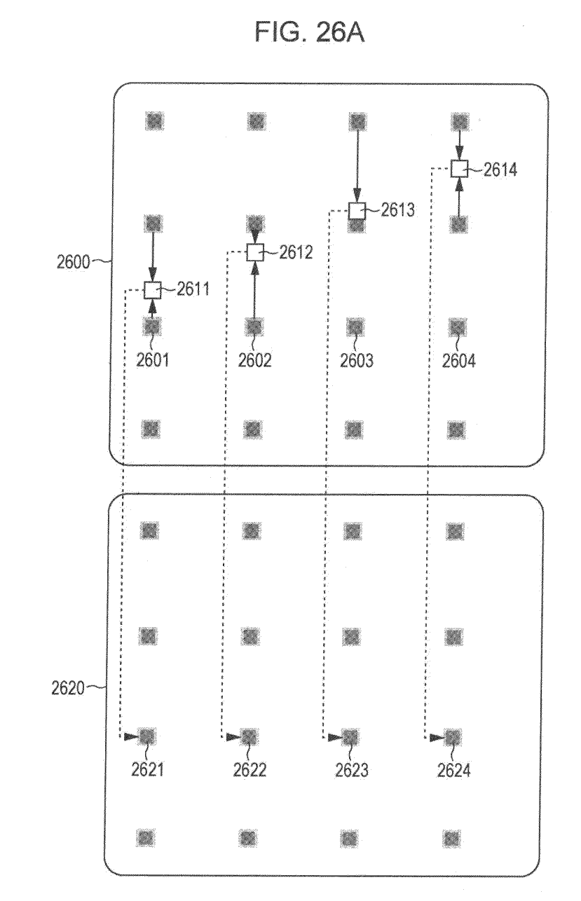

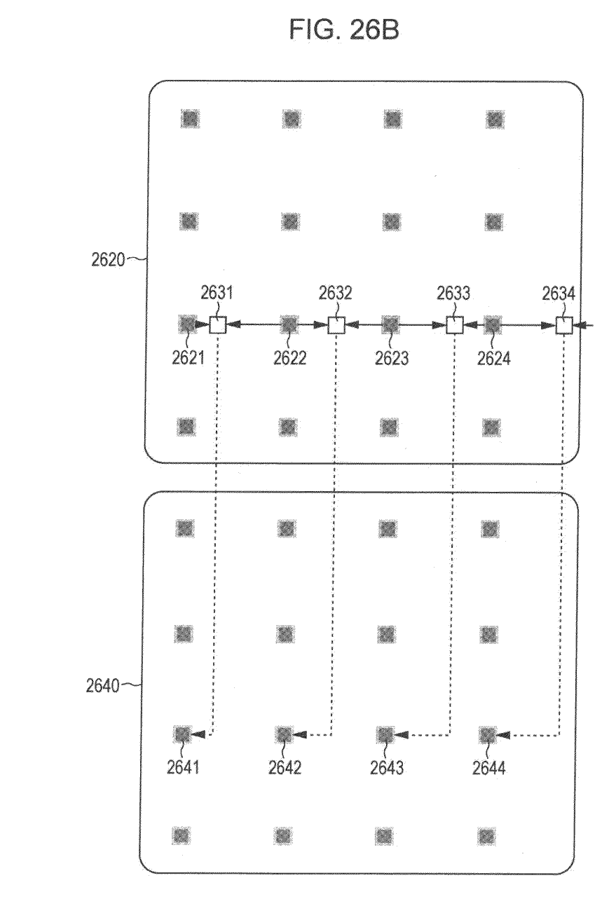

On the other hand. FIGS. 26A and 26B illustrate examples in which one dimensional conversion processing is performed using the V/H separation in the conversion processing in the vertical direction and the horizontal direction as illustrated in FIG. 24.

First, as illustrated in FIG. 26A, the pixel value V conversion unit 1653 obtains pixel positions of 2611 to 2614 after the V conversion by applying corresponding V conversion vectors in the V conversion data items 1652, respectively, with respect to each of pixels of 2601 to 2604 of the input image 2600. In addition, by writing the image information in each of pixel positions of 2611 to 2614 in each of corresponding pixels 2621 to 2624, it is possible to obtain V converted image data 2620.

Subsequently, as illustrated in FIG. 26B, the pixel value H conversion unit 1663 further obtains H converted pixel positions of 2631 to 2634 by applying corresponding H conversion vectors in the H conversion data items 1662, respectively, with respect to each of the pixels of 2621 to 2624 of the V converted image data 2620. In addition, by writing pieces of image information in the pixel positions of 2631 to 2634 in each corresponding pixels of 2641 to 2644, it is possible to obtain an input image 2640.

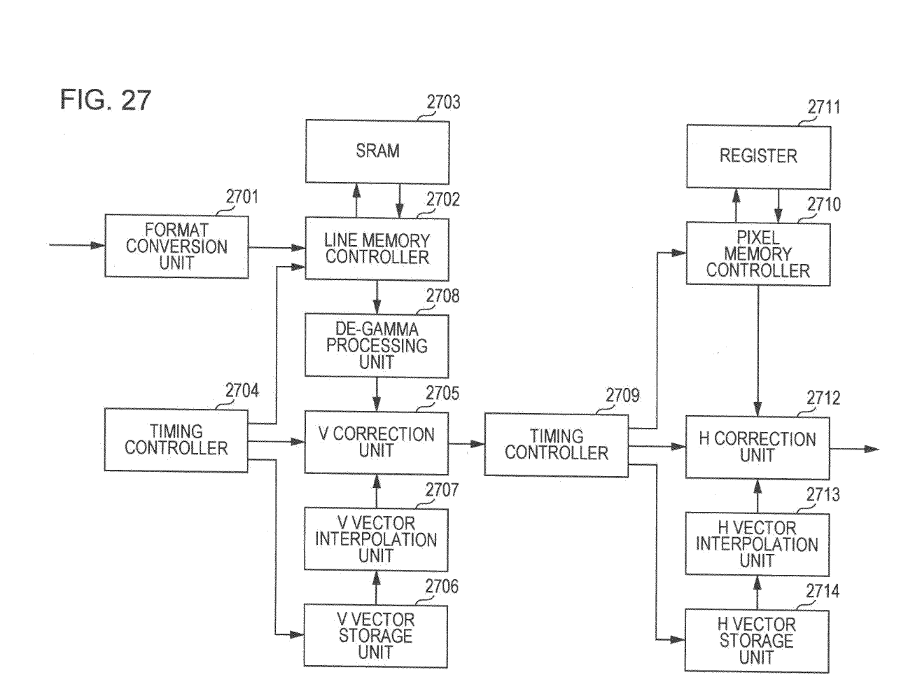

FIG. 16 illustrates a functional configuration in the image conversion processing unit 1620 by mainly paying attention to a processing algorithm. FIG. 27 illustrates a circuit block diagram for executing the processing algorithm.

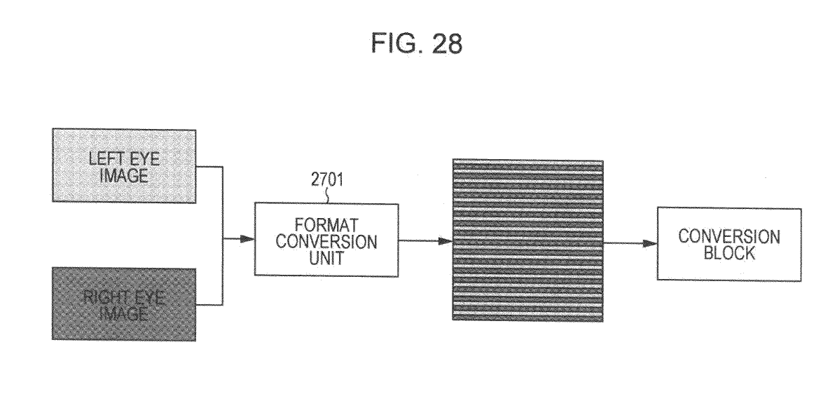

A format conversion unit 2701 performs a format conversion by inputting an input image for the left eye, and each frame of an input image for the right eye which is synchronizing. FIG. 28 illustrates a mechanism in which an input image is subject to a format conversion by the format conversion unit 2701. As illustrated, when an input image 2801 for the left eye and an input image 2802 for the right eye are input, the format conversion unit 2701 performs a format conversion into a conversion block of a “Line by Line” format in which the input image for the left eye and the input image for the right eye are alternately input line by line. In this manner, when converting into a format in which the input image 2801 for the left eye and the input image 2802 for the right eye are converted into are merged, it is possible to reduce a size of the circuit since it is possible to use the same circuit when processing the input image 2801 for the left eye and the input image 2802 for the right eye.

The image data of which the format is converted by the format conversion unit 2701 is temporarily stored in a Static RAM (SRAM) 2703 through a line memory controller 2702.

The image conversion processing unit 1620 performs the image conversion processing separating into the conversion processing in the vertical direction, and the conversion processing in the horizontal direction. The conversion processing in the vertical direction is performed by the SRAM 2703, the line memory controller 2702, the de-gamma processing unit 2708, the V correction unit 2705, the V vector interpolation unit 2707, and the V vector storage unit 2706, under a synchronization control by a timing controller 2704. On the other hand, the conversion processing in the horizontal direction is performed by a register 2711, a pixel memory controller 2710, an H correction unit 2712, an H vector interpolation unit 2713, and an H vector storage unit 2714, under the synchronization control by a timing controller 2709.

Since the image conversion processing is performed by being separated in the vertical direction and in the horizontal direction, a conversion vector in each pixel is stored in the V vector storage unit 2706 and the H vector storage unit 2714, respectively, by being separated into a V vector of vertical component and an H vector of horizontal component. In addition, it is possible to reduce an amount of memory by configuring as a table which maintains conversion vectors only for the representative points (refer to FIG. 17), without storing conversion vectors of all pixels in the V vector storage unit 2706 and the H vector storage unit 2714. A conversion vector of a pixel except for the representative point is generated using interpolation by the V vector interpolation unit 2707 and the H vector interpolation unit 2713. FIG. 18 schematically illustrates a state in which a conversion vector of a display pixel except for the representative point is obtained by interpolation processing. In FIG. 18, pixels of which conversion vectors are interpolated are denoted by a light gray color. The method of interpolation using the V vector interpolation unit 2707 and the H vector interpolation unit 2713 has already been described with reference to FIGS. 20 to 22B.

The timing controller 2704 controls a timing of interpolation processing of a conversion vector using the table interpolation unit 2707, and interpolation processing in the vertical direction using the pixel value V conversion unit 2705 when reading of image data from the SRAM 2703 by the line memory controller 2702 is performed.

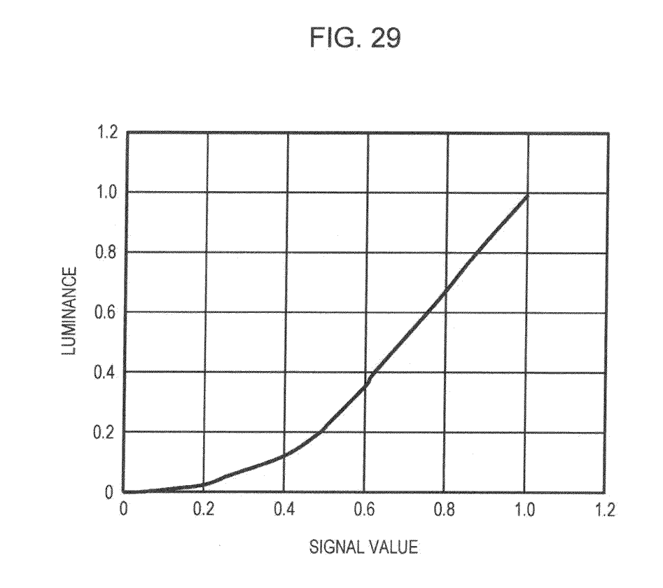

It is assumed that an input image is subject to a gamma correction in which intensity (luminance) of each basic color is adjusted according to characteristics of the display panel of the display unit 609. However, since a signal value and luminance of an image signal which is subject to the gamma correction is not linear, the luminance is changed. FIG. 29 exemplifies a relationship between a signal value and luminance of an image signal which is subject to the gamma correction, however, in the illustrated example, the luminance becomes 22% with respect to the signal value of 50%. When phase varies in each basic color, a balance of the luminance is lost, and it causes an uneven coloring when performing image conversion. Therefore, according to the embodiment, image conversion is performed by performing de-gamma processing with respect to the input image in the de-gamma processing unit 2708, and returning the signal value and the luminance to a linear shape.

The mechanism of performing the image conversion processing by separating the conversion into the vertical direction and horizontal direction is the same as that illustrated in FIG. 24. The V correction unit 2705 performs one-dimensional conversion processing 2403 in the vertical direction with respect to the input image which was subject to de-gamma processing using the V conversion vector which was subject to interpolation 2402 by the V vector interpolation unit 2707, and obtains V converted image data 2404. The V converted image data 2404 is data generated by performing a conversion 2405 in the vertical direction with respect to the input image 2401.

Subsequently, the H correction unit 2712 performs one-dimensional conversion processing 2407 in the vertical direction with respect to the V converted image data 2404 using the V conversion data which was subject to interpolation 2406 by the H vector interpolation unit 2713, and obtains V/H converted image data 2408. The V/H converted image data 2408 is data generated by further performing a conversion 2409 in the horizontal direction with respect to the V converted image data 2404.

According to the technology which is disclosed in the specification, it is possible to simulate a state in which an image which is projected onto a curved screen using a projector is viewed by a user by performing image conversion with respect to the input image so that the image information of each point when the input image is projected onto the curved screen from a projection center of the projector is displayed at a point at which a gaze of the user viewing the image information with a left eye reaches an enlarged virtual image (refer to FIGS. 4 to 6). In addition, according to the technology which is disclosed in the specification, it is possible to simulate a state in which an image which is formed by performing image conversion with respect to an input image, and is presented on a curved panel is viewed by a user so that image information of each point when the input image is presented on the curved panel is displayed at a point at which a gaze of the user viewing with a left eye reaches an enlarged virtual image.

In addition, it is possible to obtain effects of reducing an amount of memory storing conversion vectors, reducing a processing load of image conversion, and suppressing occurrence of image distortion, by performing the above described image conversion processing using the circuit configuration illustrated in FIG. 27.

### INDUSTRIAL APPLICABILITY

Hitherto, the technology which is disclosed in the specification has been described in detail with reference to specific embodiments. However, it is clear that it is possible for the person skilled in the art to perform a modification or substitution of the embodiment without departing from the scope of the technology.

The technology which is disclosed in the specification can be applied to image display devices of various types in which an image displayed using a micro display, or the like, is projected onto retinas of a user through an optical system, including a head mounted display. In addition, in the specification, embodiments in which the technology disclosed in the specification is applied to a binocular head mounted display has been mainly described, however, as a matter of course, it is also possible to apply the technology to a monocular head mounted display.

In short, the technology disclosed in the specification has been described using a form of an exemplification, and described contents of the specification are not construed as being limited. In order to determine the scope of the technology which is disclosed in the specification, claims should be taken into consideration.

In addition, the technology disclosed in the specification can also be configured as follows.

(1) An image display device which includes an image input unit which inputs an image; a display unit which displays the image; and an image conversion unit which converts an input image so that a display image on the display unit is viewed as an image which is displayed in a predetermined format.

(2) The image display device which is described in (1), in which the image conversion unit converts the input image so that the image is viewed as an image projected onto a curved screen using a projector.

(3) The image display device which is described in (2), in which the image conversion unit performs image conversion with respect to the input image so that image information of each point when the input image is projected onto the curved screen from a projection center of the projector is displayed at a point at which a gaze of a user who views the image information reaches the display image of the display unit.

(4) The image display device which is described in (1), in which the image conversion unit converts the input image so that the input image is viewed as an image which is presented on a curved panel.

(5) The image display device which is described in (4), in which the image conversion unit performs image conversion with respect to the input image so that image information of each point when the input image is presented on the curved panel is displayed at a point at which the gaze of the user viewing the image information reaches the display image of the display unit.

(6) The image display device which is described in (1), in which the image conversion unit includes a conversion table which maintains a conversion vector in which a correlation between a pixel position on the input image and a pixel position on a presented image which is output from the display unit is described only for a pixel of a representative point, and a table interpolation unit which interpolates a conversion vector of a pixel except for the representative point from the conversion table, and performs a conversion of the input image using the interpolated conversion vector.

(7) The image display device which is described in (1), in which the image conversion unit performs the conversion of the input image by separating the conversion into a vertical direction and horizontal direction.

(8) The image display device which is described in (6), in which the image conversion unit further includes a V conversion table and an H conversion table which maintain a V conversion vector in the vertical direction and an H conversion vector in the horizontal direction with respect to a representative point, respectively, a V table interpolation unit which interpolates the V conversion vector of a pixel except for the representative point from the V conversion table, and an H table interpolation unit which interpolates the H conversion vector of a pixel except for the representative point from the H conversion table.

(9) The image display device which is described in (8), in which the V table interpolation unit and the H table interpolation unit perform a table interpolation with respect to a pixel in the vertical direction based on one dimensional weighted sum of a conversion vector of a representative point which is maintained in the conversion table, and then perform a table interpolation with respect to a pixel in the horizontal direction based on one dimensional weighted sum of a conversion vector of the pixel which is interpolated in the vertical direction.

(10) The image display device which is described in (8), in which the V table interpolation unit and the H table interpolation unit interpolate a conversion vector of a pixel at a representative position which is arranged in pixel intervals of exponent of 2 using a weighted sum by calculating a weight of a neighboring representative point, and interpolate a conversion vector of a pixel between the representative positions using two tap weighted sum at even intervals, when the table interpolation is performed with respect to a pixel in the horizontal direction.

(11) The image display device which is described in (8), in which the image conversion unit further includes a pixel value V conversion unit which performs a conversion in the vertical direction with respect to the input image using a V conversion vector which is interpolated by the V table interpolation unit, and a pixel value H conversion unit which performs a conversion in the horizontal direction with respect to a converted image by the pixel value V conversion unit using an H conversion vector which is interpolated by the H table interpolation unit.

(12) The image display device which is described in (6), in which the display unit displays an image in each of left and right eyes of a user, and the image conversion unit includes only a conversion table for image of any one of the left and right eyes, and obtains a conversion vector for the other eye by performing horizontal inversion of the conversion vector for the one eye which is interpolated by the table interpolation unit.

(13) The image display device which is described in (1), in which the image input unit inputs an image for left eye and an image for right eye, and the image conversion unit performs the conversion after performing a format conversion of the input images for left and right eyes into a format in which the images are alternately inserted line by line.

(14) The image display device which is described in (1), in which the image conversion unit performs the conversion with respect to the input image after performing de-gamma processing with respect to the image.

(15) An image processing device which includes an image conversion unit which converts an image which is displayed on a display unit so that the image is viewed as an image displayed in a predetermined format.

(16) An image processing method which includes converting an image which is displayed on a display unit so that the image is viewed as an image displayed in a predetermined format.

(17) An image display device comprising: circuitry configured to input an image in a first format; display the image in a second format; and convert the input image from the first format to the second format so that the display image is viewed as a curved image.

(18) The image display device according to (17), wherein the circuitry converts the input image so that the display image is viewed as the curved image as if it was a curved displayed image.

(19) The image display device according to (17) or (18), wherein the curved displayed image is a projected image from a projector, and wherein the circuitry converts the input image so that image information of each point where the display image is projected from a projection center of the projector is displayed at a point at which a gaze of a user who views the image information reaches a corresponding portion of the curved image.

(20) The image display device according to (17), wherein the circuitry converts the input image so that the display image is viewed as the curved image, the curved image being a simulation of a curved projected image.

(21) The image display device according to any one of (17) to (20), wherein the circuitry converts the input image so that image information of each point where the display image is viewed at a point at which the gaze of the user viewing the image information reaches a corresponding portion of the curved image.

(22) The image display device according to any one of (17) to (21), wherein the circuitry includes a conversion table which maintains a conversion vector in which a correlation between a pixel position on the input image and a pixel position on the display image, which is displayed on a display, is described only for a pixel of a representative point, and wherein the circuitry is configured to interpolate a conversion vector of a pixel except for the pixel of the representative point from the conversion table, and to perform the conversion of the input image using the interpolated conversion vector.

(23) The image display device according to any one of (17) to (22), wherein the circuitry converts the input image by separating a conversion process thereof into a vertical direction conversion process and horizontal direction conversion process.

(23) The image display device according to any one of (17) to (21) and (23), wherein the circuitry includes a V conversion table and an H conversion table which maintain a V conversion vector in the vertical direction and an H conversion vector in the horizontal direction with respect to the representative point, respectively, and wherein the circuitry is configured to interpolate the V conversion vector of the pixel except for the pixel of the representative point from the V conversion table, and to interpolate the H conversion vector of the pixel except for the pixel of the representative point from the H conversion table.

(24) The image display device according to (23), wherein the circuitry is configured to perform a table interpolation with respect to a pixel in the vertical direction based on one dimensional weighted sum of a conversion vector of the representative point, which is maintained in the conversion table, and then perform a table interpolation with respect to a pixel in the horizontal direction based on one dimensional weighted sum of a conversion vector of the pixel which is interpolated in the vertical direction.

(25) The image display device according to (23), wherein the circuitry is configured to interpolate a conversion vector of a pixel at a representative position which is arranged in pixel intervals of exponent of 2 using a weighted sum by calculating a weight of a neighboring representative point, and to interpolate a conversion vector of a pixel between the representative positions using two tap weighted sum at even intervals, when the table interpolation is performed with respect to a pixel in the horizontal direction.

(26) The image display device according to (23), wherein the circuitry is configured to perform a conversion in the vertical direction with respect to the input image using a V conversion vector which is interpolated by the circuitry, and to perform a conversion in the horizontal direction with respect to a converted image of the input image by the circuitry using an H conversion vector which is interpolated by the circuitry.

(27) The image display device according to any one of (17) to (22), wherein the circuitry includes a conversion table for conversion of the input image for only one of the left and right eyes, and wherein the circuitry is configured to obtain a conversion vector for the other eye by performing horizontal inversion of the conversion vector for the one eye, which is interpolated by the circuitry.

(28) The image display device according to any one of (17) to (27), wherein the circuitry is configured to input an image for left eye and an image for right eye, and perform the conversion of the input image after performing a format conversion of the input images for the left and right eyes into a format in which the images are alternately inserted line by line.

(29) The image display device according to any one of (17) to (28), wherein the circuitry converts the input image after performing de-gamma processing with respect to the input image.

(30) An image processing system comprising: circuitry configured to convert an image to a differently formatted image for display thereof based on a predetermined curved format.

(31) The image processing system according to (30), wherein the converted image is displayed as a three-dimensional image.

(32) The image processing system according to (30) or (31), wherein the converted image is displayed in an image display device.

(33) An image processing method comprising: receiving image data in a first format; converting, using a processor, the image data from the first format to a second format different from the first format; and outputting the converted image data to produce a curved image based on the converted image data.

(34) A head-mounted display device comprising: circuitry configured to input an image in a first format, convert the input image from the first format to a second format, and cause display of the converted image in the second format such that the display image is viewable as a curved image by each of a left eye and a right eye of a wearer of the head-mounted display device.

(35) The head-mounted display device according to (34), further comprising: a left eye display; and a right eye display, wherein the circuitry is configured to cause the display of the converted image in the second format at the left eye display and at the right eye display.

### REFERENCE SIGNS LIST

401L, 401R Virtual image optical unit
403L, 403R Microphone
404L, 404R Display panel
405 Eye width adjusting mechanism
601 Control unit
601A ROM
601B RAM
602 Input operation unit
603 Remote control reception unit
604 State information obtaining unit
605 Communication unit
606 Storage unit
607 Image processing unit
608 Display driving unit
609 Display unit
610 Virtual image optical unit
612 Outer camera
613 Sound processing unit
614 Sound input-output unit
615 Outer display unit
616 Environment information obtaining unit
1600 Image conversion functional unit
1610 Image input unit
1620 Image conversion processing unit
1630 Conversion table storage unit
1631 V conversion table
1632 H conversion table
1640 Image output unit
1651 V table interpolation unit (vertical direction)
1653 Pixel value V conversion unit
1655 Horizontal inversion unit
1656 Pixel value V conversion unit
1661 H table interpolation unit (horizontal direction)
1663 Pixel value H conversion unit
1665 Horizontal inversion unit
1666 Pixel value H conversion unit
2701 Format conversion unit
2702 Line memory controller
2703 SRAM
2704 Timing controller
2705 V correction unit
2706 V vector storage unit
2707 V vector interpolation unit
2708 De-gamma processing unit
2709 Timing controller
2710 Pixel memory controller
2711 Register
2712 H correction unit
2713 H vector interpolation unit
2714 H vector storage unit

1. An image display device comprising:
circuitry configured to
input an image in a first format;
display the image in a second format; and
convert the input image from the first format to the second format so that the display image is viewed as a curved image.

2. The image display device according to claim 1, wherein the circuitry converts the input image so that the display image is viewed as the curved image as if it was a curved displayed image.

3. The image display device according to claim 2,
wherein the curved displayed image is a projected image from a projector, and
wherein the circuitry converts the input image so that image information of each point where the display image is projected from a projection center of the projector is displayed at a point at which a gaze of a user who views the image information reaches a corresponding portion of the curved image.

4. The image display device according to claim 1, wherein the circuitry converts the input image so that the display image is viewed as the curved image, the curved image being a simulation of a curved projected image.

5. The image display device according to claim 4, wherein the circuitry converts the input image so that image information of each point where the display image is viewed at a point at which the gaze of the user viewing the image information reaches a corresponding portion of the curved image.

6. The image display device according to claim 1,
wherein the circuitry includes a conversion table which maintains a conversion vector in which a correlation between a pixel position on the input image and a pixel position on the display image, which is displayed on a display, is described only for a pixel of a representative point, and
wherein the circuitry is configured to interpolate a conversion vector of a pixel except for the pixel of the representative point from the conversion table, and to perform the conversion of the input image using the interpolated conversion vector.

7. The image display device according to claim 1, wherein the circuitry converts the input image by separating a conversion process thereof into a vertical direction conversion process and horizontal direction conversion process.

8. The image display device according to claim 6,
wherein the circuitry includes a V conversion table and an H conversion table which maintain a V conversion vector in the vertical direction and an H conversion vector in the horizontal direction with respect to the representative point, respectively, and
wherein the circuitry is configured to interpolate the V conversion vector of the pixel except for the pixel of the representative point from the V conversion table, and to interpolate the H conversion vector of the pixel except for the pixel of the representative point from the H conversion table.

9. The image display device according to claim 8, wherein the circuitry is configured to perform a table interpolation with respect to a pixel in the vertical direction based on one dimensional weighted sum of a conversion vector of the representative point, which is maintained in the conversion table, and then perform a table interpolation with respect to a pixel in the horizontal direction based on one dimensional weighted sum of a conversion vector of the pixel which is interpolated in the vertical direction.

10. The image display device according to claim 8, wherein the circuitry is configured to interpolate a conversion vector of a pixel at a representative position which is arranged in pixel intervals of exponent of 2 using a weighted sum by calculating a weight of a neighboring representative point, and to interpolate a conversion vector of a pixel between the representative positions using two tap weighted sum at even intervals, when the table interpolation is performed with respect to a pixel in the horizontal direction.

11. The image display device according to claim 8, wherein the circuitry is configured to perform a conversion in the vertical direction with respect to the input image using a V conversion vector which is interpolated by the circuitry, and to perform a conversion in the horizontal direction with respect to a converted image of the input image by the circuitry using an H conversion vector which is interpolated by the circuitry.

12. The image display device according to claim 6,
wherein the circuitry includes a conversion table for conversion of the input image for only one of the left and right eyes, and
wherein the circuitry is configured to obtain a conversion vector for the other eye by performing horizontal inversion of the conversion vector for the one eye, which is interpolated by the circuitry.

13. The image display device according to claim 1,
wherein the circuitry is configured to
input an image for left eye and an image for right eye, and
perform the conversion of the input image after performing a format conversion of the input images for the left and right eyes into a format in which the images are alternately inserted line by line.

14. The image display device according to claim 1, wherein the circuitry converts the input image after performing de-gamma processing with respect to the input image.

15. An image processing system comprising:
circuitry configured to
convert an image to a differently formatted image for display thereof based on a predetermined curved format.

16. The image processing system according to claim 15, wherein the converted image is displayed as a three-dimensional image.

17. The image processing system according to claim 15, wherein the converted image is displayed in an image display device.

18. An image processing method comprising:
receiving image data in a first format;
converting, using a processor, the image data from the first format to a second format different from the first format; and
outputting the converted image data to produce a curved image based on the converted image data.

19. A head-mounted display device comprising:
circuitry configured to
input an image in a first format,
convert the input image from the first format to a second format, and
cause display of the converted image in the second format such that the display image is viewable as a curved image by each of a left eye and a right eye of a wearer of the head-mounted display device.

20. The head-mounted display device according to claim 19, further comprising:
a left eye display; and
a right eye display,
wherein the circuitry is configured to cause the display of the converted image in the second format at the left eye display and at the right eye display.
